(19) United States
(12) Patent Application Publication
(10) Pub. No.: US 2022/0170166 A1
(43) Pub. Date: Jun. 2, 2022

(54) CONVERSION OF CARBONATE INTO SYNGAS OR C2+ PRODUCTS IN ELECTROLYSIS CELL

(71) Applicant: THE GOVERNING COUNCIL OF THE UNIVERSITY OF TORONTO, Toronto (CA)

(72) Inventors: Yuguang C. Li, Toronto (CA); Geonhul Lee, West Toronto (CA); Edward Sargent, Toronto (CA)

(21) Appl. No.: 17/608,684

(22) PCT Filed: May 5, 2020
(86) PCT No.: PCT/CA2020/050598

§ 371 Date: Nov. 3, 2021

Related U.S. Application Data
(60) Provisional application No. 62/843,524, filed on May 5, 2019.

(51) Int. Cl. C25B 1/23; C25B 13/00; C25B 11/061; C25B 9/19; C25B 11/031; C25B 15/08

(52) U.S. Cl. CPC C25B 1/23; C25B 13/00; C25B 15/08; C25B 9/19; C25B 11/031; C25B 11/061

(57) ABSTRACT

Described herein are techniques for converting carbonate in a carbonate loaded solution into syngas or C2+ products within an electrolysis cell that includes a cathodic compartment, an anodic compartment and preferably a bipolar membrane separating the compartments. The carbonate ions are converted in situ by reaction with protons generated by the bipolar membrane to produce CO₂ that is in turn electrocatalytically converted into the product. The electrolysis cell can be coupled to an air or flue gas capture system that produces the carbonate loaded solution, and the depleted solution released by the electrolysis cell can be recycled back into the capture system and the feed of the electrolysis cell. The cathode can include a porous substrate that is hydrophilic, and a catalyst metal deposited on the substrate can be Cu, Ag or an alloy depending on the target product.

### TECHNICAL FIELD

The technical field generally relates to the electrosynthesis of syngas and other carbon based compounds, and more particularly to techniques for the electrocatalytic conversion of carbonate into syngas or carbon based compounds in an electrolysis cell.

### BACKGROUND

The process of CO₂ valorization—from capture of CO₂ to its electrochemical upgrading-requires significant inputs for the capture, upgrading, and separation steps. Using a gas-phase CO₂ produced by a capture-and-release stage and then fed into a CO₂ electroreduction stage leads to notable waste that adds cost and energy consumption to the CO₂ management aspect of the system. For example, between 80% and 95% of CO₂ may be wasted due to formation of undesirable compounds and/or electrolyte crossover. There is a need for technologies that overcome at least some of the disadvantages of existing techniques for CO₂ capture and conversion.

### SUMMARY

In some implementations, there is provided an electrolytic process for converting carbonate into syngas in an electrolysis cell, comprising: providing a carbonate loaded solution comprising carbonate ions (CO₃²⁻) and having a pH above 11; feeding the carbonate loaded solution into a cathodic compartment of the electrolysis cell, the cathodic compartment comprising a cathode; feeding an electrolyte into an anodic compartment of the electrolysis cell, the anodic compartment comprising an anode; applying a voltage across the anode and the cathode; generating protons within the electrolytic cell and supplying the protons within the cathodic compartment to react with the carbonate to form CO₂ and water; electrocatalytically converting the CO₂ into the syngas at the cathode and producing a carbonate depleted solution; and withdrawing the carbonate depleted solution and the syngas from the cathodic compartment and separating the syngas from the carbonate depleted solution.

In some implementations, the carbonate loaded solution comprises potassium carbonate or sodium carbonate. The carbonate loaded solution can have a CO₃²⁻ concentration of at least 0.5 M and below 2.5 M, or a CO₃²⁻ concentration of at least 0.7 M and below 2.2 M, optionally between 0.8 and 2.1 M, between 1 M and 2 M, or between 1.2 M and 1.8 M. The syngas can be produced having an H₂-to-CO ratio of approximately 2:1 to 4:1, 5:2 to 7:2, or approximately 3:1. The process can include supplying at least a portion of the syngas to a Fischer-Tropsch reaction unit to produce hydrocarbons therefrom. The cathode can include silver (Ag); the anode Nickle (Ni) or other metals. The electrolytic cell can be operated with a current density between 100 and 500 mA/cm², or between 100 and 300 mA/cm², or between 150 and 250 mA/cm². The electrolyte fed into the anodic compartment can include water and potassium hydroxide (KOH), optionally an aqueous solution with a pH from 7 to 14, preferably KOH, NaOH, and/or CsOH solutions.

Optionally, at least a portion of the carbonate depleted solution is removed from the cathodic compartment is used as at least part of an absorption solution that is supplied to a CO₂ absorber that receives a CO₂-containing gas and produces a CO₂-depleted gas and an absorber loaded solution. At least a portion of the absorber loaded solution can also be used as at least a portion of the loaded carbonate solution that is fed into the cathodic compartment. Optionally, all of the absorber loaded solution is fed into the cathodic compartment as the loaded carbonate solution. A recycle portion of the carbonate depleted solution removed from the cathodic compartment can be recycled back into the carbonate loaded solution that is fed into the cathodic compartment.

In some implementations, the protons are generated using a bipolar membrane located in the electrolysis cell. The bipolar membrane can be positioned to provide fluid separation between the cathodic compartment from the anodic compartment, and can be configured to dissociate water to generate the protons and hydroxide ions, wherein the protons move into the cathodic compartment to react with carbonate and the hydroxide ions move into the anodic compartment. The bipolar membrane can include an anion exchange layer defining a side of the anodic compartment and a cation exchange layer defining a side of the cathodic compartment. The bipolar membrane can be configured such that water is dissociated into the protons and the hydroxide ions when a given potential difference is exceeded. The anion exchange layer can include imidazolium based compounds, quaternary ammonium based compounds and/or phosphonium based compounds or any derivatives or polymers thereof. The cation exchange layer can include a perfluorosulfonic acid polymer or another material. Optionally, the given potential difference is approximately 0.8 V. The cation exchange layer can be provided to have a pKa of approximately −1 to 3, −0.5 to 2, 0 to 1.5, or 1. The bipolar membrane can be mechanically reinforced, optionally with a woven polymeric material which is optionally PEEK, polyester, polypropylene, and/or perfluoroalkoxy. In some implementations, the cathodic compartment and the anodic compartment are defined by a housing comprising side walls and separation of the cathodic compartment from the anodic compartment is provided solely by the bipolar membrane positioned within the housing. Various constructions, shapes, and configurations of the compartments are possible.

In some implementations, the protons are generated in a controlled manner in accordance with the CO₃²⁻ concentration of the carbonate loaded solution to convert at least 30%, at least 40%, at least 50% or at least 60% of the carbonate into CO₂ in situ within the cathodic compartment. The protons can be generated in an amount of 1e−6 to 5e−6, 1e−6 to 3e−6 or 1.5e−6 to 2.5e−6 mole/sec per 1 cm² of electrode area. Proton generation scales linearly with current density and electrode area, and can be provided based on calculations or design factors.

In some implementations, the pH of the carbonate loaded solution is above 11.5 upon entering the cathodic compartment, or above 12 upon entering the cathodic compartment. The pH of the carbonate depleted solution upon exiting the cathodic compartment can be between 0.2 to 0.4 lower than the carbonate loaded solution.

In some implementations, the syngas and the carbonate depleted solution are removed from the cathodic compartment as a single stream and are separated in a downstream separation stage, or wherein the syngas and the carbonate depleted solution are removed from the cathodic compartment as separate streams.

In some implementations, the cathode comprises a porous substrate and a catalytic metal provided thereon; and optionally wherein the porous substrate is hydrophilic, optionally composed of carbon paper, further optionally pre-treated with ultraviolet (UV) radiation to increase hydrophilicity; and optionally wherein the substrate has a contact angle that is less than 40 degrees, less than 30 degrees, less than 20 degrees, or less than 10 degrees, in term of hydrophilicity.

The carbonate ions in the carbonate loaded solution are fully, mostly, or partially derived from CO₂ extracted from a flue gas or air.

In some implementations, there is provided an electrolytic process for converting carbonate into a carbon based product in an electrolysis cell, comprising: feeding a carbonate loaded solution comprising carbonate ions (CO₃²⁻) and having a pH above 10 into a cathodic compartment of the electrolysis cell, the cathodic compartment comprising a cathode; feeding an electrolyte into an anodic compartment of the electrolysis cell, the anodic compartment comprising an anode; applying a voltage across the anode and the cathode; generating protons in situ within the electrolytic cell and supplying the protons within the cathodic compartment to react with the carbonate to form CO₂ and water, the protons being generated by a bipolar membrane positioned between the cathodic compartment and the anodic compartment; electrocatalytically converting the CO₂ into the carbon based product at the cathode by electroreduction and producing a carbonate depleted solution; and withdrawing the carbonate depleted solution and the carbon based product from the cathodic compartment and separating the carbon based product from the carbonate depleted solution.

In some implementations, the carbon based product comprises CO and/or a C2+ carbon compound. The C2+ carbon compound can include ethylene or ethanol. The C2+ carbon compound can incldue formate, acetate, and/or propanol. The carbon based product can also include methane. In some implementations, a plurality of carbon based products are produced, and the process further comprises separating a target carbon compound from the carbon based products.

In some implementations, the cathode comprises Cu and/or Ag. The cathode can be designed to provide desired selectivity to produce certain carbon based compounds. The cathode comprises a catalytic metal comprising, for example, Cu and Ag. The catalytic metal can be a metal alloy comprising a primary catalyst metal and a secondary metal. The primary catalyst metal can be Cu and the secondary metal can be Ag. The metal alloy can be provided on a porous substrate by co-sputtering, wherein for example the primary catalyst metal is sputtered at 150 W to 250 W, optionally at 180 W to 220 W; while the secondary metal is sputtered at 20 W to 120 W, optionally at 30 W to 50 W. The metal alloy can be provided on a porous substrate by galvanic sputtering; optionally wherein the metal alloy is formed by depositing the primary catalyst metal onto the porous substrate, and then contacting the deposited primary catalyst metal with a solution comprising ions of the secondary metal to dope a surface of the deposited primary catalyst metal with the secondary metal; and optionally wherein the molar surface concentration of the secondary metal is between 10% and 30%. Optionally, the primary metal is Cu and is deposited by sputtering, and the secondary metal is Ag and is provided as AgNO₃ in the solution into which the deposited Cu is submerged.

In some implementations, the carbonate loaded solution comprises potassium carbonate or sodium carbonate, with a CO₃²⁻ concentration of at least 0.5 M or at least 1 M.

In some implementations, the anode comprises Nickle (Ni) and/or one or more of the following: NiFeOₓ, FeCoOₓ, IrOₓ, RuOₓ, and CoOₓ. The electrolytic cell can be operated with a current density between 100 and 300 mA/cm², or between 150 and 250 mA/cm², or between 150 and 200 mA/cm², or other current densities depending on the target carbon based compound for example.

In some implementations, at least a portion of the carbonate depleted solution removed from the cathodic compartment is used as at least part of an absorption solution that is supplied to a CO₂ absorber that receives a CO₂-containing gas and produces a CO₂-depleted gas and an absorber loaded solution. At least a portion of the absorber loaded solution can be used as at least a portion of the loaded carbonate solution that is fed into the cathodic compartment. In some implementations, all of the absorber loaded solution is fed into the cathodic compartment as the loaded carbonate solution. A recycle portion of the carbonate depleted solution removed from the cathodic compartment can also be recycled back into the carbonate loaded solution that is fed into the cathodic compartment.

The bipolar membrane can be positioned to provide fluid separation between the cathodic compartment from the anodic compartment, and can be configured to dissociate water to generate the protons and hydroxide ions, wherein the protons move into the cathodic compartment to react with carbonate and the hydroxide ions move into the anodic compartment. The bipolar membrane can include an anion exchange layer defining a side of the anodic compartment and a cation exchange layer defining a side of the cathodic compartment. The bipolar membrane can be configured such that water is dissociated into the protons and the hydroxide ions when a given potential difference is exceeded. The anion exchange layer can include imidazolium based compounds, quaternary ammonium based compounds and/or phosphonium based compounds or any derivatives or polymers thereof. The cation exchange layer can include a perfluorosulfonic acid polymer or another material. Optionally, the given potential difference is approximately 0.8 V. The cation exchange layer can be provided to have a pKa of approximately −1 to 3, −0.5 to 2, 0 to 1.5, or 1. The bipolar membrane can be mechanically reinforced, optionally with a woven polymeric material which is optionally PEEK, polyester, polypropylene, and/or perfluoroalkoxy. In some implementations, the cathodic compartment and the anodic compartment are defined by a housing comprising side walls and separation of the cathodic compartment from the anodic compartment is provided solely by the bipolar membrane positioned within the housing, and optionally wherein the bipolar member is arranged in parallel relation with respect to the cathode and the anode. Various constructions, shapes, and configurations of the compartments are possible. The protons can be generated by the bipolar membrane in a controlled manner in accordance with the CO₃²⁻ concentration of the carbonate loaded solution to convert at least 40% or at least 50% or at least 60% of the carbonate into CO₂ in situ within the cathodic compartment. The protons can be generated in an amount of 1e−6 to 5e−6, 1e−6 to 3e−6 or 1.5e−6 to 2.5e−6 mole/sec per 1 cm² of electrode area.

In some implementations, the pH of the carbonate loaded solution is above 11, above 11.5, above 12, above 12.5 or above 13, upon entering the cathodic compartment. The pH of the carbonate depleted solution upon exiting the cathodic compartment can be between 0.2 and 0.5 lower than the pH of the carbonate loaded solution.

In some implementations, the carbon based product and the carbonate depleted solution are removed from the cathodic compartment as a single stream and are separated in a downstream separation stage, or wherein the carbon based product and the carbonate depleted solution are removed from the cathodic compartment as separate streams. The carbon based product can be generated as a gas phase. The gas phase carbon based product can be removed from the liquid phase carbonate depleted solution using a gas-liquid separator.

In some implementations, the cathode comprises a porous substrate and a catalytic metal provided thereon; and optionally wherein the porous substrate is hydrophilic, optionally composed of carbon paper, further optionally pre-treated with ultraviolet (UV) radiation to increase hydrophilicity; and optionally wherein the substrate has a contact angle that is less than 40 degrees, less than 30 degrees, less than 20 degrees, or less than 10 degrees, in term of hydrophilicity; and optionally wherein the substrate is composed of graphite, Ni, Fe, Cu, Ti, stainless steel and is a foam, sheet or mesh.

In some implementations, the carbonate ions in the carbonate loaded solution are fully, mostly, or partially derived from CO₂ extracted from a flue gas or air; and optionally wherein the CO₂ concentration in the air is about 0.3% to 0.5% or about 0.4% and the CO₂ concentration in the flue gas is about 20% to 30% or about 25%.

In some implementations, there is provided an integrated CO₂ capture and electrocatalytic conversion system, comprising: (i) an absorber comprising: a gas inlet for receiving a CO₂ containing gas; a liquid inlet for receiving an absorption solution; an absorption chamber coupled to the gas inlet and the liquid inlet for enabling contact between the CO₂ containing gas and the absorption solution to produce a CO₂ depleted gas and a loaded solution; a gas outlet for releasing the CO₂ depleted gas; and a liquid outlet for releasing the loaded solution; and (ii) an electrolysis cell comprising: (a) a cathode unit comprising: a liquid inlet for supplying a carbonate loaded solution, the liquid inlet being in fluid communication with the liquid outlet of the absorber and under conditions such that the carbonate loaded solution carbonate loaded solution comprises carbonate ions (CO₃²⁻) and has a pH above 10; a cathodic compartment in fluid communication with the liquid inlet for receiving the carbonate loaded solution; a cathode positioned in the cathodic compartment for contacting the carbonate loaded solution and electrocatalytically producing a carbon based product and a carbonate depleted solution; and at least one outlet in fluid communication with the cathodic compartment configured to release the carbonate depleted solution and the carbon based product; (b) an anode unit comprising: a liquid inlet for supplying an electrolyte; an anodic compartment in fluid communication with the liquid inlet for receiving the electrolyte; an anode positioned in the anodic compartment for contacting the electrolyte and electrocatalytically generating oxygen; and an outlet in fluid communication with the anodic compartment configured to release the electrolyte; (c) a bipolar membrane separating the cathodic compartment and the anodic compartment, and configured to: generate protons that enter the cathodic compartment to react with the carbonate therein to form water and CO₂, which is electrocatalytically converted into the carbon based product at the cathode; and generate OH⁻ ions that enter the anodic compartment; and (d) a power supply coupled to the anode and the cathode to provide a voltage therebetween.

In some implementations, the absorber is configured to be a direct-contact absorber wherein the CO₂ containing gas and the absorption solution are directly contacted together in the absorption chamber. The absorber can be a packed column type unit wherein the absorption chamber comprises packing material, although the absorber could be other reactor types such as a spray unit or a fluidized bed unit. The absorber is configured to receive air as the CO₂ containing gas.

In some implementations, the carbon based product comprises CO and the cathode further catalytically generates H₂ to form syngas. The at least one outlet of the cathode unit releasing the syngas can be coupled to an upgrading unit, such as a Fischer-Tropsh unit configured to receive the syngas from the electrolysis cell and produce hydrocarbons therefrom.

In some implementations, the carbon based product comprises a C2+ carbon compound. The C2+ carbon compound can include ethylene, ethanol, formate, acetate, and/or propanol. The carbon based product can also include methane. A plurality of carbon based products can be produced, and the process can include separating a target carbon compound from the carbon based products.

In some implementations, the cathode comprises Cu or Ag or a catalytic metal which can include Cu and Ag, for example. The catalytic metal can include a metal alloy comprising a primary catalyst metal and a secondary metal. The primary catalyst metal comprises Cu and the secondary metal comprises Ag. The metal alloy can be provided on a porous substrate by co-sputtering or galvanic sputtering, as described above and/or herein.

The system can also have various other features as described above and/or herein in terms of, for example, features of the carbonate loaded solution, the anode, the cathode, the electrolyte, and the like.

In some implementations, the system also includes an absorber recycle line in fluid communication between the outlet of the cathode unit and the liquid inlet of the absorber to provide at least a portion of the carbonate depleted solution as at least part of the absorption solution supplied to the absorber. All of the absorber loaded solution can be fed into the cathodic compartment as the loaded carbonate solution. In some implementations, the system also includes a return line in fluid communication from the outlet of the cathode unit to the inlet of the cathode unit to provide a portion of the carbonate depleted solution back into the carbonate loaded solution to form a combined feed that is supplied into the cathodic compartment.

In some implementations, the bipolar membrane and the electrolysis cell comprise one or more features that are described above and/or herein.

In some implementations, the cathode unit has a single outlet for releasing the carbon based product and the carbonate depleted solution as a single stream, and the system further comprises a separator for separating the carbon based product from the carbonate depleted solution. Alternatively, the cathode unit can have at least two outlets such that the carbon based product and the carbonate depleted solution are removed from the cathodic compartment as separate streams. The carbon based product can be generated as a gas phase which can facilitate separation from the carbonate depleted solution.

In some implementations, the system also includes a monitoring assembly configured to measure one or more of the following parameters: pH of the carbonate loaded solution prior to entering the cathodic compartment, temperature of the carbonate loaded solution prior to entering the cathodic compartment, pH of the carbonate depleted solution exiting the cathodic compartment, liquid flow rate of carbonate. In some implementations, the system also includes a control assembly configured to receive one or more of the measured parameters, and to control one or more of the following variables: pH of the carbonate loaded solution, current density provided by the power supply, flow of the carbonate depleted solution recycled back to the absorber, flow of the carbonate depleted solution returned to the cathodic compartment, the temperature of the carbonate loaded solution prior to entering the cathodic compartment, liquid flow rate of carbonate.

In some implementations, there is provided an electrolysis cell for converting carbonate into carbon based products, comprising: (a) a cathode unit comprising: a liquid inlet for supplying a carbonate loaded solution comprising carbonate ions (CO₃²⁻); a cathodic compartment in fluid communication with the liquid inlet for receiving the carbonate loaded solution; a cathode positioned in the cathodic compartment for contacting the carbonate loaded solution and electrocatalytically producing a carbon based product and a carbonate depleted solution, the cathode comprising: a porous substrate composed of a hydrophilic material, and a catalytic metal deposited on the porous substrate, the catalytic metal comprising Cu doped with Ag; at least one outlet in fluid communication with the cathodic compartment configured to release the carbonate depleted solution and the carbon based product; (b) an anode unit comprising: a liquid inlet for supplying an electrolyte; an anodic compartment in fluid communication with the liquid inlet for receiving the electrolyte; an anode positioned in the anodic compartment for contacting the electrolyte and electrocatalytically generating oxygen; and an outlet in fluid communication with the anodic compartment configured to release the electrolyte; (c) a bipolar membrane separating the cathodic compartment and the anodic compartment, and configured to: generate protons that enter the cathodic compartment to react with the carbonate therein to form water and CO₂, which is electrocatalytically converted into the carbon based product at the cathode; and generate OH⁻ ions that enter the anodic compartment; and (d) a power supply coupled to the anode and the cathode to provide a voltage therebetween.

In some implementations, there is provided an electrolytic process for converting carbonate into a carbon based product in an electrolysis cell, comprising: providing a carbonate loaded solution comprising carbonate ions (CO₃²⁻); feeding the carbonate loaded solution into a cathodic compartment of the electrolysis cell, the cathodic compartment comprising a cathode that comprises: a porous substrate composed of a hydrophilic material, and a catalytic metal deposited on the porous substrate, the catalytic metal comprising Cu doped with Ag; feeding an electrolyte into an anodic compartment of the electrolysis cell, the anodic compartment comprising an anode; applying a voltage across the anode and the cathode; generating protons within the electrolytic cell and supplying the protons within the cathodic compartment to react with the carbonate to form CO₂ and water; electrocatalytically converting the CO₂ into the carbon based products at the cathode and producing a carbonate depleted solution; and withdrawing the carbonate depleted solution and the carbon based products from the cathodic compartment and separating the carbon based products from the carbonate depleted solution.

In some implementations, at least 40%, 50%, 60%, 70% or 80% of the carbonate present in the carbonate loaded solution is converted in the electrolysis cell. In some implementations, at least some carbonate in the carbonate depleted solution is recycled back into the electrolysis cell, optionally wherein the recycle is controlled to provide a constant carbonate concentration, e.g., within 1 mol %, 2 mol %, 5 mol % or 10 mol %, in the feed to the electrolysis cell.

In some implementations, there is provided the use of an electrolysis cell for receiving a carbonate loaded solution having a pH of at least 10 and for converting carbonate ions in the carbonate loaded solution into carbon based products selected from carbon monoxide, ethylene, and ethanol. Also provided is the use of an electrolysis cell for receiving a carbonate loaded solution derived from a CO₂ capture system that captures CO₂ from air or flue gas and converting carbonate ions in the carbonate loaded solution into carbon based products selected from carbon monoxide, ethylene, and ethanol. The electrolysis cell can have one or more features as defined above or herein.

It is also noted that the processes, systems, uses, and cells described above or herein can include one or more features as defined in any other of the paragraphs or sections of the present specification.

### BRIEF DESCRIPTION OF DRAWINGS

FIG. 1. (a) Carbon loss mechanisms in a CO₂ electrolysis cell with gas-fed CO₂, (b) illustration of the bipolar membrane generating CO₂ in situ via the acid/base reaction of proton and carbonate ion, and (c) Chemical balance of the direct carbonate electrolysis cell with bipolar membrane (BPM).

FIG. 2. Performance of the direct carbonate electrolysis cell. (a) Full cell j-V curve with Ag and Cu catalyst. (b) Product distribution for the Ag catalyst. H₂ and CO are the major products, summing up to ˜100% of the total FE. (c) Product distribution for the Cu catalyst. Propanol, formate and acetate are detected as well in small amount. FIGS. 2 (a)-(c) are conducted in 1 M K₂CO₃ catholyte with nitrogen purging as controls to demonstrate the concept of in situ CO₂ generation. 1 M KOH and Ni foam were used at the anode. (d) The product distribution of an Ag catalyst under different applied current density (1^{st} x-axis, mA/cm²) in different concentration of KOH electrolyte (2^{nd} x-axis) purged with CO₂ prior to reaction, simulating the product of a CO₂ capture solution.

FIG. 3. Stability evaluation of the direct carbonate electrolysis cell. CO₂ gas was first captured with KOH solution and transferred to an electrolysis bottle with no gas purging. The amount of gas produced from the electrolysis was measured with a mass flow meter and the ratio of H₂ and CO was monitored with GC injection. 1 M KOH and Ni foam were used at the anode. The cell was held at constant potential of 3.8V.

FIG. 4. Technoeconomic analysis of the MEA cell with gas-fed CO₂ with different energy costs for CO₂ capture and different energy cost for products separation.

FIG. 5. SEM images of the as-synthesized Ag catalyst.

FIG. 6. SEM images of the as-synthesized Cu catalyst.

FIG. 7. XRD diffraction pattern of the Ag catalyst. The reflection labelled with “*” is contributed from the carbon substrate.

FIG. 8. (a) A graph of faradaic efficiency versus different catalysts at different current densities showing production of carbon based products, (b) a graph of C₂H₄ faradaic efficiency versus current density for different catalysts, and (c) a graph of C₂H₄ faradaic efficiency versus current density for different catalysts.

FIG. 9a is a schematic of part of a system that includes a cathode and a bipolar membrane for converting carbonate into ethylene, and FIG. 9b is a graph of faradaic efficiency versus current density showing the production of carbon based products.

FIG. 10. A process block diagram of a system for CO₂ capture from a flue gas in an absorber to produce a carbonate loaded solution followed by conversion of the carbonate into a carbon based product in an electrolysis cell.

### DETAILED DESCRIPTION

The present description relates to the use of carbonate in an electrolysis cell to be transformed into syngas or other carbon based products. Within the electrolysis cell, the carbonate in aqueous solution can be converted into CO₂ via in situ contact with protons and the resulting CO₂ can then be catalytically converted into syngas (CO and H₂) or other carbon based products depending on the electrocatalyst that is implemented in the electrolysis cell. The electrolysis cell can therefore facilitate a single-step operation to convert carbonate into an upgraded product that can be used as a chemical feedstock, for example. The process can leverage the acid/base reaction between protons and carbonate to implement the single-step carbonate reduction. The protons can be provided by using a bipolar membrane, which generates protons under applied potential conditions.

The electrocatalytic reduction of CO₂ to value added products can enable the storage of intermittent renewable energy and offers to reduce net CO₂ emissions. While there is a large effort in the scientific community focused on catalyst development, the electrolysis system design is also important to the successful implementation of this technology. Today, many efforts on CO₂ conversion process separate two key steps: (i) CO₂ capture and (ii) CO₂ utilization (e.g., upgrade, valorization, electrochemical reduction, etc.). One approach to the first step involves CO₂ capture in the form of a carbonate salt, which then requires the energy-intensive release of CO₂ from the carbonate salt which can be done by desorption in a stripping tower. In the subsequent electrolysis step, CO₂ is provided in gas form, as an output from the capture and release step. The CO₂ utilization rate is relatively inefficient as CO₂ is wasted, in part because in the best-performing CO₂RR systems the use of alkali electrolyte leads to considerable carbonate formation. Further CO₂ losses arise due to the crossover of products and often of unwanted bicarbonate to the anode. Finally, separation of the final products adds further cost. In the end, the overall CO₂ conversion generates a large carbon footprint from each step, making the process net carbon positive.

However, an electrolysis system design that instead—in a single step-directly takes CO₂ from capture in the form of a carbonate loaded solution, and generates upgraded a chemical feedstock such as syngas, can facilitate various enhancements. The system can use the acid/base reaction between protons and carbonate to implement the direct carbonate reduction, optionally by exploiting bipolar membranes where protons are generated from the bipolar membrane under applied potential conditions react with carbonate to release CO₂ in situ at the membrane:catalyst interface.

As will be described in further detail below, in one experimentally demonstrated embodiment, the process can use an Ag catalyst to generate syngas at approximately 3:1 hydrogen-to-CO ratio, which is optionally chosen for the Fischer Tropsch reaction. Because the carbon source in the electrolysis is carbonate—a liquid phase reactant—the syngas exiting the electrolysis cell can be relatively pure and not diluted with CO₂ gas. This work demonstrated the stability of the system under 145 hours of continuous operation at 180 mA/cm². This work also reports a 35% full cell energy efficiency and the H₂:CO ratio remains stable across the entire study. In addition, this work compared the energy cost for the complete CO₂ conversion from capture to product extraction for several existing CO₂ electrolyzer designs. It was found that the direct carbonate cell described herein requires about 4 times less energy per product molecule compared to a CO₂-fed membrane-electrode-assembly (MEA) cell, and requires about 20 times less energy compared to an alkaline flow cell. This study further reports CO₂ electrolysis from carbonate electrolyte, generating value added products and achieving up to approximately 100% carbon utilization (i.e., very little to no carbon waste). Implementations of the systems and processes described herein can facilitate notable energy and cost efficiencies.

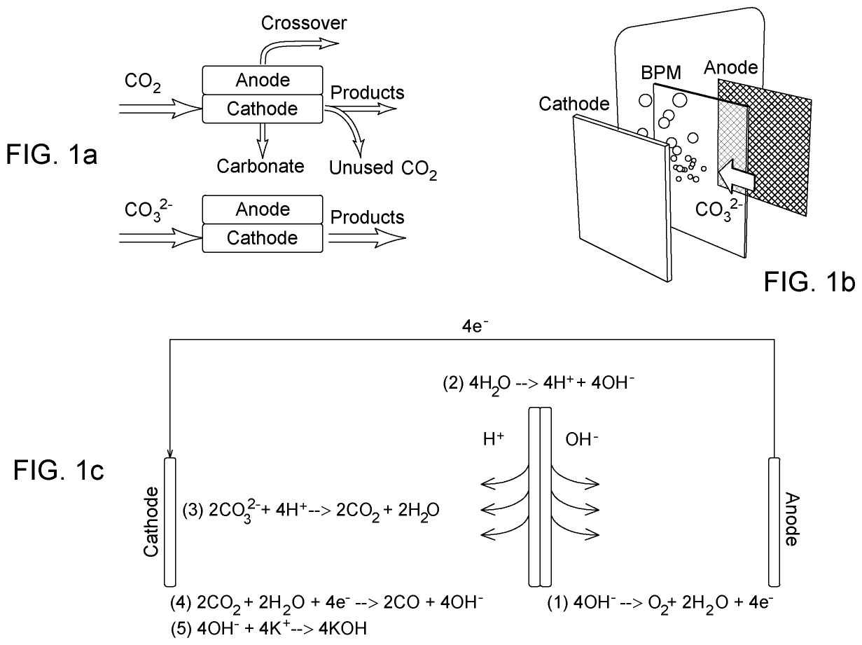

CO₂ capture systems often use alkali hydroxide solutions to form alkali carbonate, and this requires additional energetic steps to dry and calcite the carbonate salt to generate a pure gas-phase CO₂ stream for the subsequent electrolysis reaction. Direct electrochemical reduction of carbonate from the CO₂ capture solution facilitates bypassing the energy-intensive calcination or desorption step, and reducing the carbon footprint of the CO₂-to-products process. The use of carbonate solution as a feed stream to the electrolysis cell also addresses several limitations in known CO₂RR systems, e.g., CO₂ waste arising due to the conversion of CO₂ gas into carbonate anions, especially in alkaline solutions. In known methods, carbonate anions can travel through an anion exchange membrane (AEM), along with some CO₂RR products, and can be oxidized at the anode. Additionally, as much as 80% of the input CO₂ gas may simply exit the electrolysis cell unreacted with many systems exhibiting low single-pass utilizations even along the input-to-output gas channel. As illustrated in FIG. 1a, with the loss of CO₂ through carbonate formation, electrolyte crossover, and low single pass conversion efficiency, the utilization of carbon is low in many previous CO₂RR electrolyzer designs. FIG. 1b shows a conventional catalyst-membrane approach that uses a membrane-electrode-assembly (MEA) design.

In the present work, CO₂RR electrolysis was carried out using carbonate solution directly as the carbon supply to the electrolysis cell. It was found that 100% carbon utilization of input-carbon-to-products could be achieved, evidenced from the lack of gaseous CO₂ at the experimental reactor outlet. The process can be performed by leveraging the facile acid/base reaction between proton and carbonate anion. The electrolysis cell system can generate CO₂ in situ from carbonate to initiate CO₂RR. For example, the system can include a bipolar membrane (BPM) which dissociates water to generate proton and hydroxide and directs them to the cathode and anode respectively. Carbonate electrolyte circulates to the cathode via a pump (e.g., a peristaltic pump in the experimental system). Under applied potential conditions, the BPM proton reacts with carbonate to generate CO₂ near the membrane:cathode interface (i.e., the interface between the cathodic metal catalyst and the porous diffusion membrane substrate attached to it, see FIG. 1b) and the carbonate is reduced to value-added products via various CO₂RR. The chemical balance of an example system is presented in FIG. 1c where CO2 is generated in situ from the carbonate and then converted into syngas.

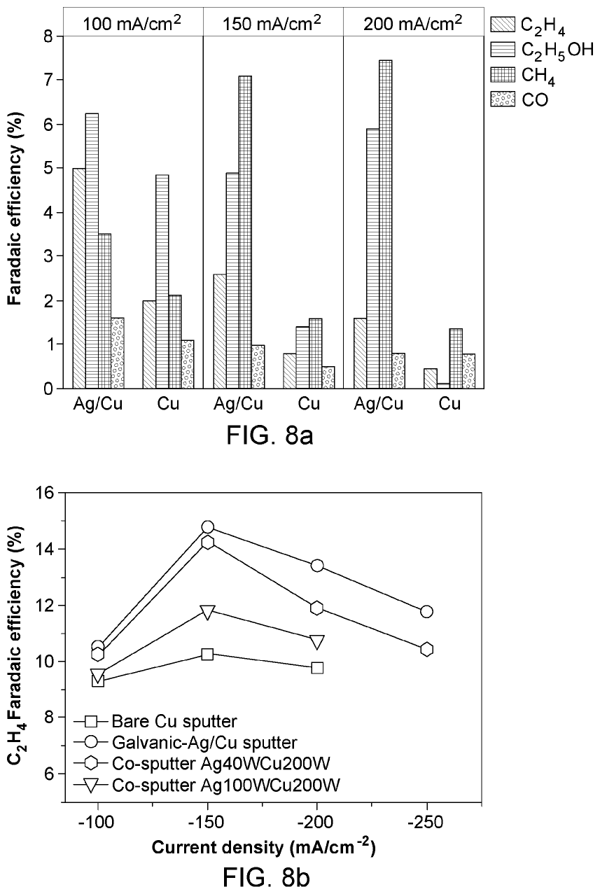

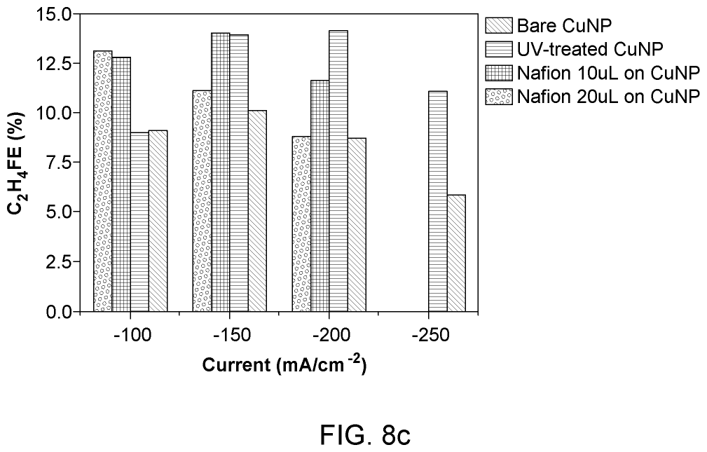

In terms of the substrate, the carbonate solution diffuses through it and past the catalyst to the membrane. A hydrophilic substrate can facilitate transport of the carbonate solution. The substrate can be carbon based and can be paper or have another structure. The substrate can be surface-treated to render it more hydrophilic. The substrate could also be made of various materials, such as Ti, Ni, Cu, Fe, stainless steel foam/sheet/mesh or polymer materials. It is noted that for a conventional CO₂ gas electrolyzer, the CO₂ is fed into the unit in gas phase and it first diffuses through the substrate and then to the catalyst; gas diffusion is minimally affected by the substrate and hydrophobic surface is usually preferred for water management purposes. For the carbonate system, the process considerations are different and thus substrate selection and the related mechanisms can also be different. In some implementations, the substrate can be a molded graphite laminate having one or more of the following properties: thickness (at 50 kPa) of 180 to 200 microns, bulk density of 0.44 g/cm3, porosity of 70% to 85% or 75% to 80%, gas permeability of 1800 to 2000 ml*mm/(cm²*hr*mmaq), gas permeability (Gurley sec) of 2 to 2.4, electrical resistivity (through plane) of 70 to 80 mΩcm, Flexural Strength of 40 to 50 MPa, Flexural Modulus of 12 to 18 GPa, and Tensile Strength of 60 to 70 N/cm. The substrate can have a PTFE treatment or not, and/or can have a Microporous Layer (MPL) or not. For example, various AvCarb® substrates could be used. Various porous materials could be used as the substrate. For the substrate, both conductive and non-conductive materials could work, though additional processing can be required for non-conductive materials. FIG. 8a shows data for various different products using different catalyst materials at different current densities.

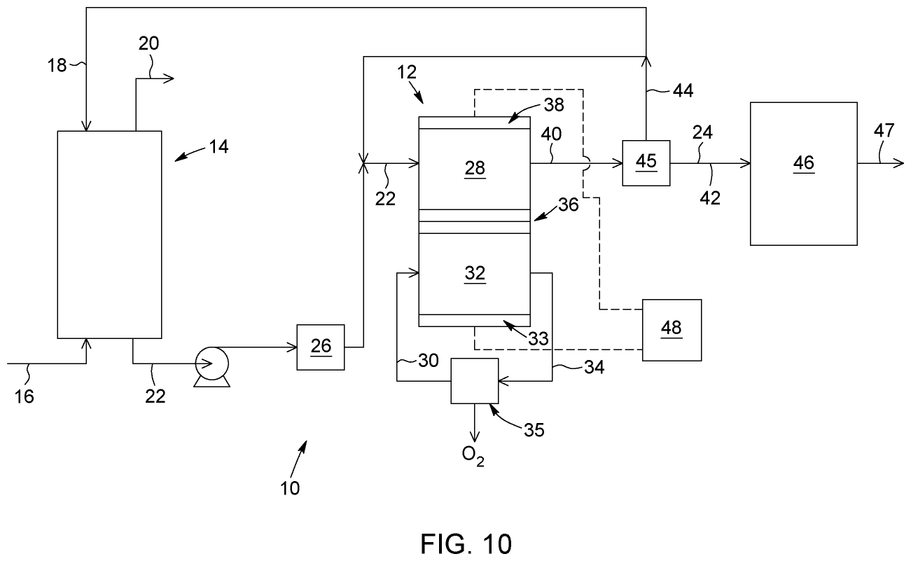

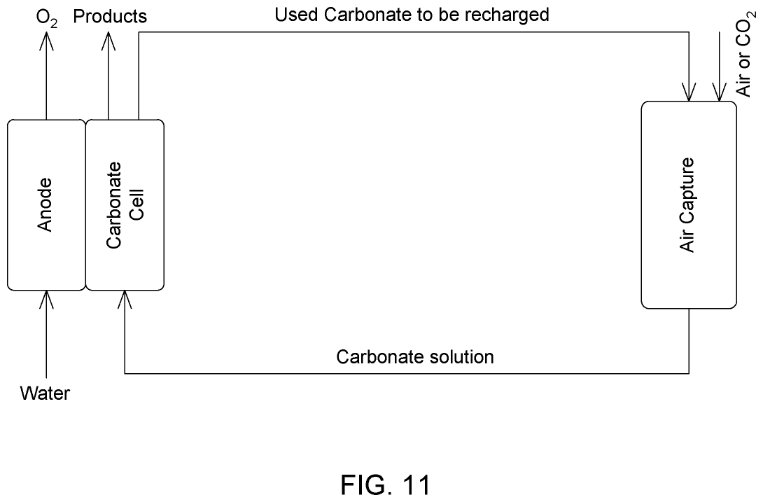

FIG. 10 illustrates an example CO₂ capture and conversion system 10 that includes an electrolysis cell 12 that converts carbonate into a carbon based product. The system 10 includes an absorber 14 configured to absorb CO₂ from a CO₂ containing gas 16, which can be air or a flue gas for example, using an absorption solution 18 that enters the absorber 14. The absorber can be a direct-contact absorber where the absorption solution 18 directly contacts the CO₂ containing gas 16. Such absorbers 14 can be packed columns or other types of absorbers. It is also noted that membrane-based absorbers could also be used where the CO₂ containing gas 16 and the absorption solution contact each other through a membrane. The absorber 14 generates a CO₂ depleted gas 20 and a loaded solution 22. The absorber 14 can be operated such that the loaded solution 22 has a relatively high pH so that the absorbed CO₂ is substantially in the form of carbonate. The pH of the loaded solution 22 can be above 10, above 10.5, above 11, above 11.5, above 12, above 12.5 or above 13. With high pH substantially all of the absorbed CO₂ in the loaded solution 22 can be in carbonate form. It is also noted that some of the absorbed CO₂ could be in the form of bicarbonate if the pH is within a certain range.

Still referring to FIG. 10, the carbonate loaded solution 22 can be pumped to the electrolysis cell 12 for conversion of the carbonate into a carbon based product 24, such as syngas or a C2 product (e.g., ethylene, ethanol). The carbonate loaded solution 22 can be subjected to a pre-treatment 26 prior to the electrolysis cell 12. The pre-treatment 26 can include passing the fluid through a heat exchanger to heat or cool the carbonate loaded solution 22 depending on the operating conditions of the absorber 14 and the electrolysis cell 12. The pre-treatment 26 could also include other treatments that modify the pH, composition, temperature, pressure or other parameters of the carbonate loaded solution 22 prior to introduction into the electrolysis cell 12.

Referring still to FIG. 10, the carbonate loaded solution 22 is fed into a cathodic compartment 28 of the electrolysis cell 12, while an electrolyte 30 is fed into an anodic compartment 32 of the electrolysis cell 12. The electrolyte 30 can be an aqueous potassium hydroxide solution which is enriched in oxygen due to oxygen formation at the anode 33 and it leaves the anodic compartment 32 as an oxygen enriched electrolyte 34. The oxygen enriched electrolyte 34 is then treated in a removal unit 35 to remove oxygen and recycled back into the anodic compartment 32 as a regenerated electrolyte.

The electrolysis cell 12 can also have a bipolar membrane 36 provided in between the anodic compartment 32 and the cathodic compartment 28. The bipolar membrane 36 becomes saturated with water and enables electrolytic splitting of the water due to the electric field of the electrolysis cell 12. The water splits and form protons and hydroxide ions, the former entering the cathodic compartment 28 and the latter entering the anodic compartment 32. The protons react with the carbonate in the carbonate loaded solution 22 in order to form CO₂, which is in turn catalytically converted into the carbon based product at the catalyst-substrate interface of the cathode 38.

The cathodic compartment 28 can have one or more outlets. When one outlet is provided, the output stream 40 comprises the carbon based products, water, as well as any unreacted carbonate or other compounds. The output stream 40 can then be separated into a product stream 42 and a recycle stream 44 for recycling back into the absorber 14 and/or back into the electrolysis cell 12, which can be performed using a product separator 45. The output stream and/or the product stream 42 could be subjected to other treatments, such as the removal of moisture, prior to downstream upgrading. The recycle stream 44 can have a pH such that all or substantially all of the CO₂ is in the form of aqueous carbonate and/or bicarbonate, thus enabling simple and effective separation from gaseous products and recycling back into the process. When the carbon based products are vapours at the operating conditions while the recycle stream 44 is liquid, the separation can be performed as a simple gas-liquid separation.

The product stream 42 containing the carbon based products can then be fed into an upgrading unit 46 for upgrading to other compounds. For example, when the carbon based products are syngas, the upgrading unit 46 can be a Fischer-Tropsch units to produce hydrocarbons or other upgraded products 47. When the carbon based product comprises a mixture of compounds, the upgrading unit can include an initial separation stage for separating the compounds into different streams or cuts. When the carbon based product comprises ethylene, the product stream 42 can be fed into any number of ethylene conversion or processing units to produce oligomers, polymers, or other upgraded products 47.

It is also noted that the electrolysis cell 12 includes a power source 48 to provide a voltage between the anode 33 and cathode 38. The power source 48 can be configured to provide a constant voltage or constant current, based on the operating strategy. The power source can also be configured and operated to provide current densities that provide a proton production rate that is tailored to the carbonate concentration of the carbonate loaded solution 22 in order to convert a notable amount of the carbonate ions into the carbon based product.

Referring now to FIG. 11, another diagram of a potential process is shown for a paired capture-electrolysis industrial process based on the carbonate electrolysis cell (also referred to as a carbonate electrolyzer). Air or flue gas can be captured with an industrial capture tower, the generated carbonate liquid solution can be circulated into the electrolyzer to generate various desirable hydrocarbon products or syngas depending on the application, which can be done in part by selecting the catalyst material and operating conditions. Some of the carbonate solution can be consumed in the electrolyzer, while the stock solution can be circulated back into the air capture tower to restart the process. An existing capture unit could be retrofitted with an electrolyzer as described herein in order to regenerate the carbonate solution for the capture unit as well as produce value-add products. In addition, an existing upgrading unit (e.g., Fischer-Tropsh unit or ethylene conversion unit) could be retrofitted by adding the electrolyzer and optionally a CO₂ capture unit or other source of carbonate solution.

### Experimentation, Examples & Calculations

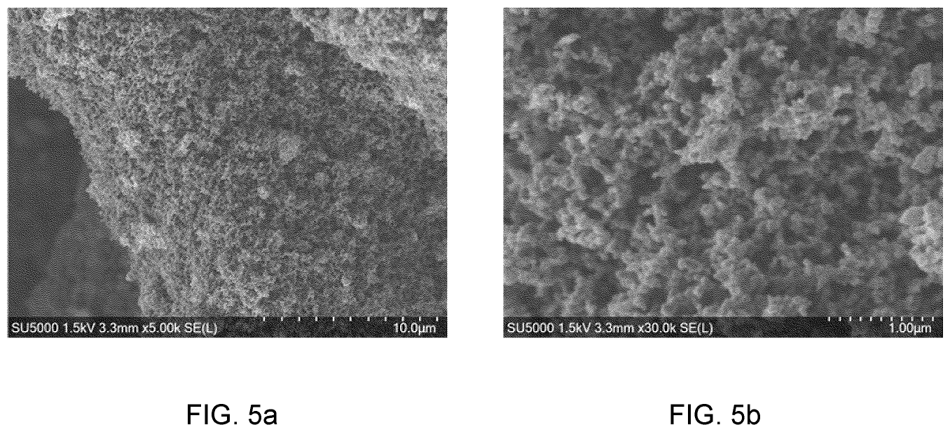

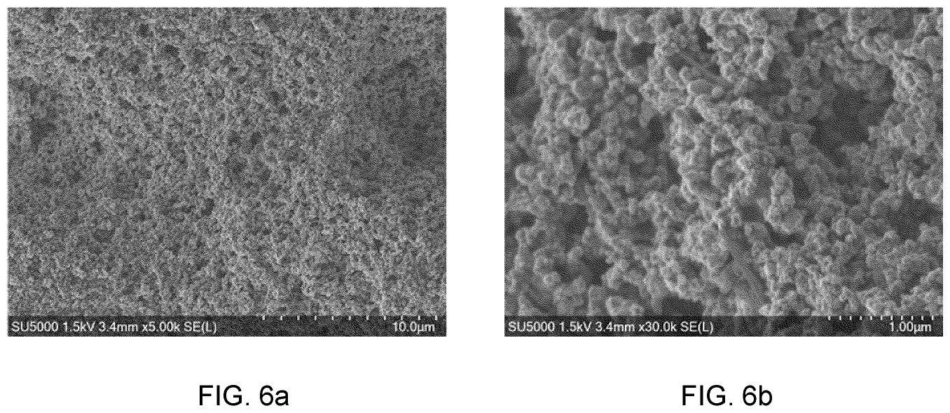

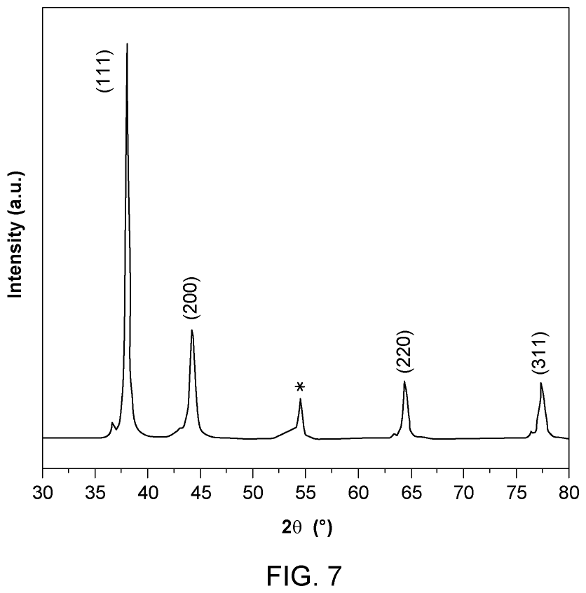

This work experimentally evaluated performance using Ag electrocatalysts (FIG. 5) and Cu electrocatalysts (FIG. 6) in 1 M K₂CO₃ electrolyte.

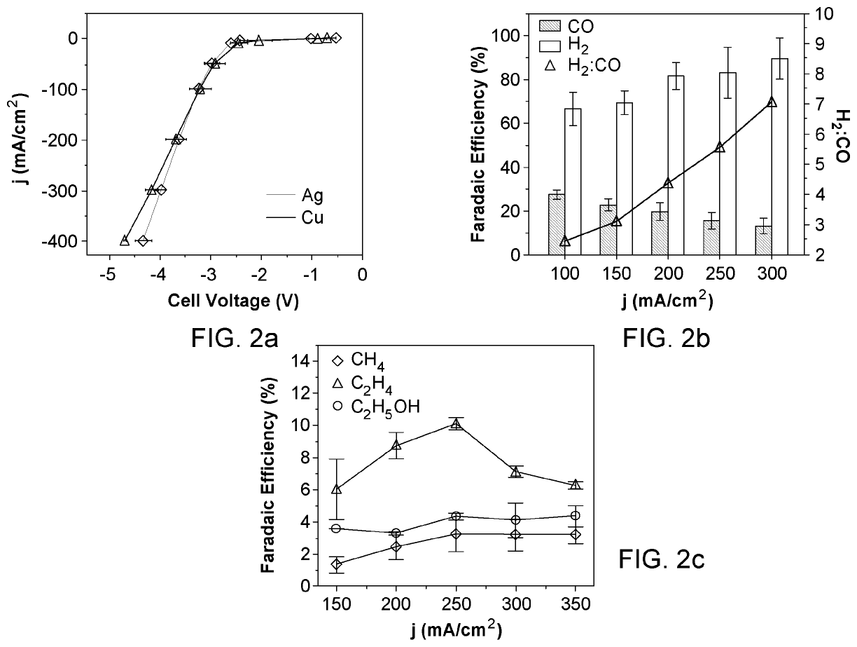

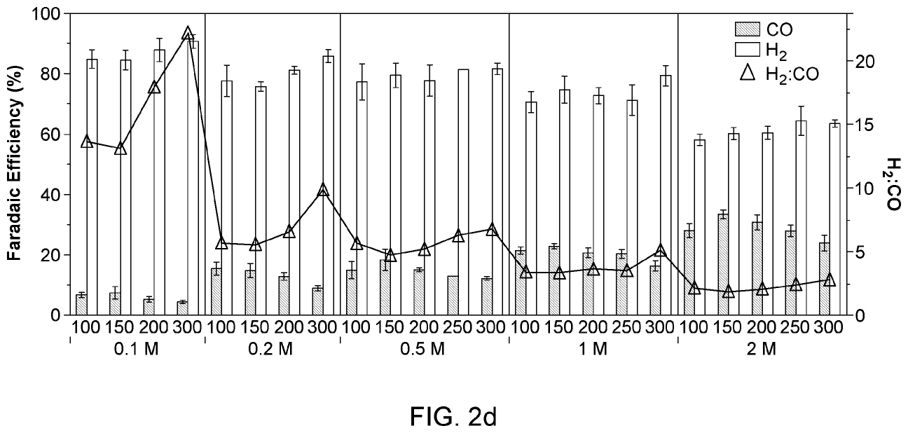

The catholyte in FIGS. 2a to 2c was purged with N₂ to ensure that there is no dissolved CO₂. Ni foam was used as the anode with 1 M KOH electrolyte, a non-precious catalyst in an alkaline condition, favorable for the oxygen evolution reaction. All studies herein report the full cell voltage, which includes the series resistance, transport and kinetic overpotentials, from the cathode, anode and membrane, as seen for example in FIG. 2a. The onset full-cell potentials for both Ag and Cu catalysts were observed at ca. 2.2 V, with Ag showing faster kinetics at higher applied potentials. For the Ag catalyst (FIG. 2b), the CO Faradaic Efficiency (FE) ranges from 28% to 12% at the applied current densities of 100 mA/cm² to 300 mA/cm², with the remainder of the FE being hydrogen. This yields a syngas ratio (H₂:CO) from ca. 2.5 to 7, suitable as feedstock to the Fischer-Tropsch (FT) reaction. Since the source of carbon in this reaction is carbonate—a liquid phase reactant—the gas product exiting the electrolysis cell is pure syngas with a small amount of moisture. Gas chromatography confirms no CO₂ is detected from the gas outlet stream. The full cell energy efficiency (EE) is 35% at 150 mA/cm², where the contributions of both CO and H₂ are included.

With a Cu catalyst, ca. 10% FE of ethylene is detected, as well as small amount of ethanol and methane. In total, 17% CO₂RR to hydrocarbon products was achieved. The full product distribution is available in Table 5.

The BPM also offers the benefit of mitigating product crossover as a result of the electro-osmotic drag of the proton emerging from the membrane, opposing the direction of products migration from cathode to anode. Anolytes from the Cu catalyst experiments were checked, and no liquid products were detected on the anode side. With this system design, the carbon loss mechanisms in a typical flow cell are notably overcome: CO₂ reaction with electrolyte to form carbonate; product crossover in the AEM system; and low single pass CO₂ utilization.

This work also examined the compatibility of the direct carbonate electrolysis cell in different CO₂ capture solutions directly. CO₂ gas was bubbled into 0.1 to 2 M of KOH solutions, simulating an industrial CO₂ capture process, and the CO₂ purged electrolyte was tested for carbonate electrolysis, the results being showed in FIG. 2d. The pH of the capture solution after CO₂ purging was approximately 11, which indicates that carbonate was the primary carbon species after CO₂ capture. With an Ag catalyst, the CO FE performance was observed to increase directly with respect to the concentration of the KOH electrolyte. This is likely due to the increase of the capture-generated K₂CO₃ concentration. The best performance of the KOH—CO₂ capture electrolyte shows a few percentage improvements compared to the pure K₂CO₃ electrolyte (FIG. 2b). This is likely due to the small amount of bicarbonate salt present in the solution, generating small amount CO₂ via chemical equilibrium, and also small amount of dissolved CO₂, both giving additional sources of reactant.

In the full system chemical balance provided in FIG. 1c, carbonate is consumed as the source of carbon in the cathodic reaction, and hydroxide is generated: this has the effect of regenerating the CO₂ capture solution. A capture-and-electrolysis system design can therefore operate continuously: the KOH capture solution removes CO₂ from air or flue gas, forming carbonate; the carbonate electrolyte is then reduced to form value-added products via electrolysis with high carbon utilization; and the capture solution is thereby regenerated to restart the cycle.

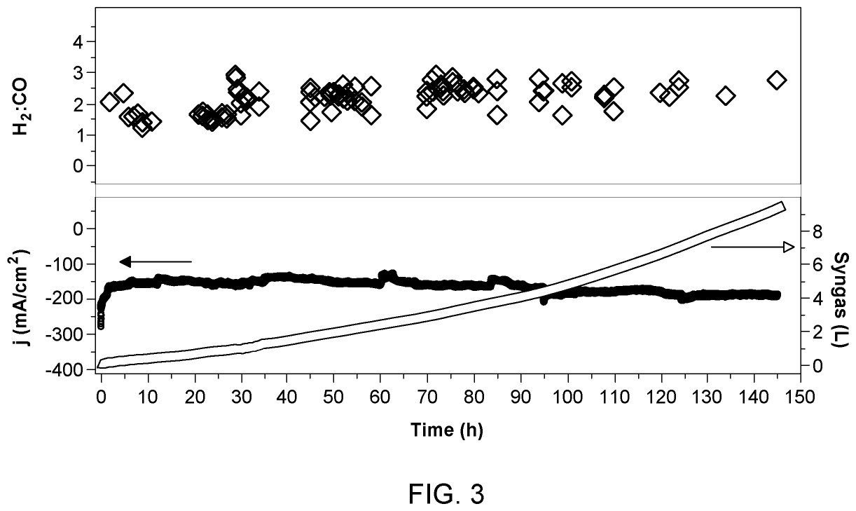

This work demonstrated a capture-electrolysis system in continuous operation for 145 hours with an Ag catalyst (see FIG. 3). Two electrolyte bottles were used: one for capturing CO₂ gas directly with KOH electrolyte, and a second one for electrolysis. The carbonate capture solution and the electrolysis electrolyte are exchanged with a peristaltic pump. The electrolyte in the electrolysis bottle is pumped to the direct carbonate cell with no gas purging. Syngas generated from the reaction exits the bottle to a mass flow meter. The flow rate of gas products was recorded to calculate the total gas produced. During the 145 hours of electrolysis, the current density was stable at ca. 180 mA/cm² due to the pH balance and crossover prevention benefits offered by the BPM. The H₂:CO ratio also remains stable at between 2 and 3. Approximately 10 L of syngas were collected.

To assess the economics of the direct carbonate reduction, this work also calculated the energy cost per product molecule, considering the full process all the way from CO₂ capture and electrolysis to separation processes. The following was evaluated: an alkaline flow cell (see reference 14), an MEA cell with gas-fed CO₂, and an implementation of the direct carbonate cell as described herein.

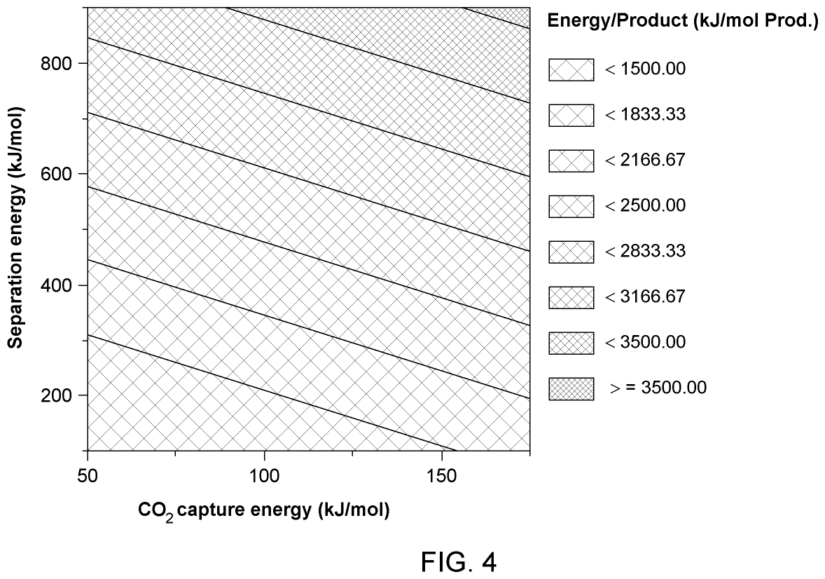

Table 1 summarizes the results. The total energy required to generate 1 mole of products is 4 times higher in the MEA cell with gas-fed CO₂ and 20 times higher for the alkaline flow cell. FIG. 4 shows the energy capital per product molecule as a function of the CO₂ capture cost and the separation cost. Even in the best-case scenario (low capture cost and low separation cost), the energy cost for CO₂RR in today's gas-fed CO₂ MEA cells is about two times higher than in the direct carbonate cell. Regeneration costs associated with removing carbonate from the electrolyte and from the anodic side add further to the expense of producing fuels and feedstocks in the gas-fed CO₂ MEA cell.

TABLE 1
Energy cost for the alkaline flow cell, CO₂ gas-fed
MEA cell and direction carbonate cell. The cost
of CO₂ capture was taken to be 178 kJ/mol and
the energy cost of separation is 500 kJ/mol.

| | Flow | | Direct |
|---|---|---|---|
| Energy Capital | Cell | MEA | CO₃²⁻ |
| CO₂ Utilization | 3 | 20 | 100 |
| carbonate formation (%) | 45 | 0 | 0 |
| crossover (%) | 2 | 30 | 0 |
| Exit CO₂ (%) | 50 | 50 | 0 |
| CO₂ caputure | 5943 | 892 | 0 |
| (kJ/mol of product) | | | |
| CO₂ required (mol) | 33 | 5 | 1 |
| CO₂ Electrolysis | 476 | 733 | 733 |
| (kJ/mol of product) | | | |
| EE (%) | 54 | 35 | 35 |
| Separation (kJ/mol) | 8333 | 1250 | 0 |
| Energy/Product | 14753 | 2874 | 733 |
| (kJ/mol of product) | | | |

A number of features could be further developed in the direct carbonate cell. The thermodynamic onset potential for CO₂ reduction to syngas is approximately 1.34 V, and the experimental onset potential is ca. 2.2 V. The overpotential was large compared to a water electrolyzer, which obtains 1 A/cm² using less than 1 V of full cell overpotential. The optimization of each cell component can be explored to increase the full cell EE further and thereby lower the energy consumption for CO₂RR. While the gas products generated in the direct carbonate electrolysis cell may not contain CO₂, moisture is a component that is present in the exit stream, and can benefit from separation before the syngas is utilized. There are also several competing reactions on the cathodic side. When a proton is generated from the BPM, it can be reduced directly on the cathode, leading to HER; when CO₂ is generated from carbonate, it can react with KOH, forming carbonate again, instead of being reduced in CO₂RR; and the proton from the BPM can also simply react with KOH in the electrolyte to form water. The penalties for these side reactions are reflected in less-than-100% total Faradaic efficiencies seen herein. The study of syngas in this report benefits from an industrially chosen preference of 30% CO₂-to-CO mixed with H₂, thus fits well with the finite FE to CO; but future studies of carbonate-to-products can be performed using further insights, progress, and innovation to other higher value products in better conversion efficiency.

In terms of some chemical modifications, changing the catalyst, e.g., from Ag to Ag/Cu, could control the reaction selectivity, such as suppressing the HER and this catalyst development could be tested on with the process describe herein to test catalyst performance. In terms of some system changes, the concentration of the inlet carbonate was screened and it was found that if the concentration is too low, there may not be enough reactant while if the concentration is too high the carbonate will be converted to bicarbonate instead of CO₂ and it is not effective for reaction. It was found that the optimal point can be around 1-2 M carbonate in some implementations.

The system design herein achieves direct carbonate conversion via the acid/base reaction of proton and carbonate, which generates an in-situ source of CO₂, enabled by the use of a bipolar membrane. The device enabled continuous operation for 145 hours and generated pure syngas in an optimal ratio suited for subsequent FT reaction. A faradaic efficiency of 17% total carbonate-to-hydrocarbon products was also achieved when we used a Cu catalyst. This study demonstrates the direct implementation of carbonate to CO₂RR products from a CO₂ capture solution and with an output gas product suitable for the FT reaction. It enables direct CO₂ utilization from air or flue gas capture to hydrocarbon products.

The following references are incorporated herein by reference in their entirety:
(1) Keith, D. W.; Holmes, G.; St. Angelo, D.; Heidel, K. A Process for Capturing CO₂ from the Atmosphere. Joule 2018, 2 (8), 1573-1594.
(2) Sanz-Perez, E. S.; Murdock, C. R.; Didas, S. A.; Jones, C. W. Direct Capture of CO₂ from Ambient Air. Chem. Rev. 2016, 116 (19), 11840-11876.
(3) Dinh, C. T.; Burdyny, T.; Kibria, M. G.; Seifitokaldani, A.; Gabardo, C. M.; Garcia de Arquer, F. P.; Kiani, A.; Edwards, J. P.; De Luna, P.; Bushuyev, O. S.; Zou, C.; Quintero-Bermudez, R.; Pang, Y.; Sinton, D.; Sargent, E. H. CO₂ Electroreduction to Ethylene via Hydroxide-mediated Copper Catalysis at an Abrupt Interface. Science 2018, 360 (6390), 783.
(4) Lv, J.-J.; Jouny, M.; Luc, W.; Zhu, W.; Zhu, J.-J.; Jiao, F. A Highly Porous Copper Electrocatalyst for Carbon Dioxide Reduction. Adv. Mater. 2018, 30 (49), 1803111.
(5) Li, Y. C.; Yan, Z.; Hitt, J.; Wycisk, R.; Pintauro, P. N.; Mallouk, T. E. Bipolar Membranes Inhibit Product Crossover in CO₂ Electrolysis Cells. Adv. Sustainable Syst. 2018, 2 (4), 1700187.
(6) Dinh, C.-T.; Li, Y. C.; Sargent, E. H. Boosting the Single-Pass Conversion for Renewable Chemical Electrosynthesis. Joule 2019, 3 (1), 13-15.
(7) Li, Y. C.; Zhou, D.; Yan, Z.; Gongalves, R. H.; Salvatore, D. A.; Berlinguette, C. P.; Mallouk, T. E. Electrolysis of CO₂ to Syngas in Bipolar Membrane-Based Electrochemical Cells. ACS Energy Lett. 2016, 1 (6), 1149-1153.
(8) Yan, Z.; Zhu, L.; Li, Y. C.; Wycisk, R. J.; Pintauro, P. N.; Hickner, M. A.; Mallouk, T. E. The Balance of Electric Field and Interfacial Catalysis in Promoting Water Dissociation in Bipolar Membranes. Energy Environ. Sci. 2018, 11 (8), 2235-2245.
(9) Vermaas, D. A.; Smith, W. A. Synergistic Electrochemical CO₂ Reduction and Water Oxidation with a Bipolar Membrane. ACS Energy Lett. 2016, 1 (6), 1143-1148.
(10) Klerk, A. d., Fischer-Tropsch Process. In Kirk-Othmer Encyclopedia of Chemical Technology, 2013.
(11) Ramdin, M.; Morrison, A. R. T.; de Groen, M.; van Haperen, R.; de Kler, R.; van den Broeke, L. J. P.; Trusler, J. P. M.; de Jong, W.; Vlugt, T. J. H. High Pressure Electrochemical Reduction of CO₂ to Formic Acid/Formate: A Comparison between Bipolar Membranes and Cation Exchange Membranes. Ind. Eng. Chem. Res, 2019, 58 (5), 1834-1847.
(12) Lee, C. H.; Kanan, M. W. Controlling H+ vs CO₂ Reduction Selectivity on Pb Electrodes. ACS Catal. 2015, 5 (1), 465-469.
(13) Min, X.; Kanan, M. W. Pd-Catalyzed Electrohydrogenation of Carbon Dioxide to Formate: High Mass Activity at Low Overpotential and Identification of the Deactivation Pathway. J. Am. Chem. Soc. 2015, 137 (14), 4701-4708.
(14) Verma, S.; Lu, X.; Ma, S.; Masel, R. I.; Kenis, P. J. A. The Effect of Electrolyte Composition on the Electroreduction of CO₂ to CO on Ag Based Gas Diffusion Electrodes. PCCP 2016, 18 (10), 7075-7084.
(15) Ho, M. T.; Allinson, G. W.; Wiley, D. E. Reducing the Cost of CO₂ Capture from Flue Gases Using Pressure Swing Adsorption. Ind. Eng. Chem. Res, 2008, 47 (14), 4883-4890.
(16) Aaron, D.; Tsouris, C. Separation of CO₂ from Flue Gas: A Review. Sep. Sci. Technol. 2005, 40 (1-3), 321-348.
(17) Verma, S.; Lu, S.; Kenis, P. J. A. Co-electrolysis of CO₂ and Glycerol as a Pathway to Carbon Chemicals with Improved Technoeconomics Due to Low Electricity Consumption. Nature Energy 2019.
(18) Carmo, M.; Fritz, D. L.; Mergel, J.; Stolten, D. A Comprehensive Review on PEM Water Electrolysis. Int. J. Hydrogen Energy 2013, 38 (12), 4901-4934.
(19) Jouny, M.; Luc, W.; Jiao, F. General Techno-economic Analysis of CO₂ Electrolysis Systems. Ind. Eng. Chem. Res, 2018, 57 (6), 2165-2177.

The following sections provide supplementary information regarding the experimentation and other aspects described herein.

### Experimental Methods

Catalysts synthesis. All reagents used in this work were purchased from Sigma Aldrich without further purification. Ag catalysts were prepared by spray coating Ag nanoparticle ink onto a sputtered Ag film. For the Ag film, Ag was first sputtered on a carbon paper (AvCarb MGL190™, Fuel Cell Store™) using an Ag target at the sputtering rate of ˜1 Ås⁻¹ in order to fabricate a 300 nm thick Ag film. 200 mg of Ag nanoparticles were then dispersed in a mixture of 10 mL of methanol, 125 uL of Nafion and 50 mg of carbon black (Super P® Conductive, Alfa Aesar™) and then sonicated for 1 hr. On the top of the Ag film, the Ag nanoparticle ink was spray coated with a loading of ˜2 mg/cm² and dried under atmosphere conditions. Cu catalysts was prepared by spray coating Cu nanoparticles ink onto a Cu film. For the Cu film, Cu was first sputtered on a carbon paper (AvCarb MGL190™. Fuel Cell Store™) using a Cu target at a sputtering rate of −1 Ås⁻¹ in order to fabricate a 300 nm thick Cu film. 200 mg of Cu nanoparticles were then dispersed in a mixture of 10 mL of methanol and 400 uL of Alkaline inomer (Sustainion® XA-9, Dioxide Materials), and then sonicated for 1 hr. On the top of the Cu film, the Cu nanoparticles ink was spray coated with a loading of ˜2 mg/cm² and dried under atmosphere conditions.

Materials characterizations. The Ag and Cu catalysts were characterized by field emission scanning electron microscopy (Hitachi®, SU5000), showing uniform coating over the entire carbon paper and porous structure down to the 100s of nm scale. X-ray diffraction (MiniFlex600™) data was collected with Cu Kα as the radiation source.

Electrochemical characterizations. Electrochemical characterization was performed using an electrochemical station (PGSTAT204™) with a commercial membrane electrode assembly (MEA) cell (Dioxide Materials). The as synthesized Ag or Cu catalyst was used as the cathode catalyst and Ni foam was used as the anode catalyst. A bipolar membrane (Fumasep FBM™, Fuel Cell Store™) was used as the separator in accordance to the manuscript. The catholyte (40 ml) was either 1 M K₂CO₃ or CO₂ saturated KOH and it is circulated using a peristaltic pump. The anolyte (40 ml) is 1 M KOH and it is circulated to using a peristaltic pump. The j-V polarization curve was obtained by applying constant currents to the cell for three minutes and averaging the stable voltages from the last minute.

The gas phase products are analyzed using a gas chromatography (Clarus® 580) coupled with a thermal conductivity detector (TCD) and a flame ionization detector (FID), with Ar as the carrier gas. The liquid phase products are characterized by high performance liquid chromatography (UltiMate 3000™). Typically, 1 ml of liquid sample was injected into the HPLC after 20 min of operation. All Faradaic efficiency (FE) measurements were repeated three times for average and error bar.

The syngas full cell energy efficiency (EE) with the Ag catalyst is calculated according to the equation below:

$$Energy Efficiency = \frac{{E}_{C O}}{Applied potential} \times {FE}_{C O} + \frac{{E}_{{H}_{2}}}{Applied potential} \times {FE}_{{H}_{2}}$$

where the Eco (1.34 V) and E_{H2} (1.23 V) are the thermodynamic onset voltage for CO and hydrogen generation respectively.

Long term stability test. The stability test was operated in a capture-electrolysis configuration (FIG. S5). CO₂ was first captured using a 2 M KOH solution generating carbonate and simulating the industrial capture process; the carbonate saturated solution is delivered to a 2^{nd} bottle with a peristaltic pump with no gas purging. Total electrolyte between the capture bottle and the electrolysis bottle is about 1.5 L. The carbonate saturated electrolyte is then pumped to the carbonate cell with an Ag catalyst, Ni foam and BPM as the cathode, anode and separation membrane respectively. 1 M KOH was used as the anolyte and circulated to the anode in similar fashion to the cathode. The cell was held at a constant potential of −3.8 V for the whole duration of the test. The gas products exit the reaction is measured with a mass flow meter to determine the total volume generated. The gas contents were collected and monitored by gas chromatography periodically during the stability test in order to confirm the H₂:CO ratio.

### Technoeconomic Analysis

To assess the economic value of the direct carbonate cell, we compared it with well-known CO₂RR systems—alkaline flow cell (see reference 3) and gas-fed MEA cell. The energy capital for the overall CO₂ reduction is divided to three steps—CO₂ capture, electrolysis and products separation. We fully noted that the economic performance of each system depends on the targeted products, reaction conditions, operation scale and many more other factors. This exercise provides a first-degree estimation of the basic energy cost only.

CO₂ Capture. The energy consumption for the CO₂ capture step, based on the generation of 1 mole of product, is calculated using the CO₂ utilization rate and the CO₂ capture energy cost. The CO₂ capture energy cost in Table 1 was given a value of 178.3 kJ/mol based on air capture. We should note that the CO₂ capture step with hydroxide solution is thermodynamically downhill, this energy cost is required for the CO₂ release from carbonate step. This number could vary based on the capture technology and FIG. 4 in the main manuscript explores the effect of this value from 50 to 178 kJ/mol.

The existing CO₂RR systems suffer from carbonate formation, crossover and low single pass conversion. Thus, to generate 1 mole of product, a higher amount of input CO₂ is required. In the case of the alkaline flow cell, we estimate 45% of CO₂ loss to carbonate formation, 2% loss to crossover and 50% loss to unreacted exit. This leave us with a 3% CO₂ utilization, which in term requires 33 moles of CO₂ for 1 mole of product. The total energy cost for CO₂ capture is then calculated as 5943 kJ/mol product for the alkaline flow cell. In the gas-fed MEA cell, the catholyte of the MEA system is humidified CO₂, therefore, the system is free from carbonate formation. However, humidified CO₂ forms bicarbonate ions with water moisture; and under applied potential condition with an AEM membrane, bicarbonate is the only anion available for transport across the membrane. The work estimated a 30% CO₂ loss due to crossover from our own experimental observations running MEA system. We also assume 50% CO₂ loss to unreacted CO₂ similar to the alkaline flow cell system. The CO₂ capture energy requirement for the gas-fed MEA cell is then 892 kJ/mole of product. In comparison to the two existing systems, the direct carbonate reduction system is able to convert 1 mole of carbonate to 1 mole product directly. The system reaches 100% of CO₂ utilization and the capture energy is 0.

$$Energy Cost for Capturing = Capture energy ( \frac{kJ}{mole of {CO}_{2}} ) \times \frac{1 mol of product}{{CO}_{2} Utilization ( \% )}$$

TABLE 2

| | Flow | | Direct |
|---|---|---|---|
| Energy Capital | Cell | MEA | CO₃²⁻ |
| CO₂ Utilization | 3 | 20 | 100 |
| carbonate formation (%) | 45 | 0 | 0 |
| crossover (%) | 2 | 30 | 0 |
| Exit CO₂ (%) | 50 | 50 | 0 |
| CO₂ capture (kJ/mol Prod.) | 5943 | 892 | 0 |

Electrolysis. The electrolysis energy required for the CO₂ reduction is based on the theoretical Gibb's free energy of reaction for CO₂-to-CO divided by the full cell energy efficiency. Energy efficiency of each system is obtained from literature and this work. The best record of energy efficiency for the flow cell system is 54%. The EE for the direct carbonate reduction system in this study is 35% and we assume a similar performance can be achieved in gas-fed MEA system. The energy costs are then 476 kJ/mole for the alkaline flow cell system, 733 kJ/mole for the MEA system and the direct carbonate system.

$$Energy cost for electrolysis = Δ {G}_{c o} ( \frac{kJ}{mole of CO} ) / Energy efficiency ( \% )$$

$$Where Δ {G}_{c o} = 257.2 kJ / mol$$

TABLE 3

| | Flow | | Direct |
|---|---|---|---|
| Energy Capital | Cell | MEA | CO₃²⁻ |
| CO₂RR (kJ/mol Prod.) | 476 | 733 | 733 |
| EE (%) | 54 | 35 | 35 |

Products separation. In this work, we assume a fix cost of 500 kJ/mol for products separation. We note that this number has considerable variation and we explored value from 100 kJ/mol up to 900 kJ/mol in FIG. 4 in the main manuscript.

$$Separation energy = Fix cost ( \frac{kJ}{mole of gas} ) \times gas emission at outlet ( mol )$$

The gas emission at the outlet is defined as the unreacted CO₂, along with products, exiting the electrolyzer after the capture and electrolysis steps. We note that syngas was the targeted product in this study and we have 0 energy cost for separation. However, if a different targeted product from CO₂RR is required, such as ethylene, separation cost of ethylene from hydrogen is still required.

TABLE 4

| | Flow | | Direct |
|---|---|---|---|
| Energy Capital | Cell | MEA | CO₃²⁻ |
| Separation (kJ/mol) | 8333 | 1250 | 0 |

In conclusion, the total energy required for the overall CO₂ conversion is then the sum of the individual energy requirements from the capture, electrolysis and separation steps.

TABLE 5
Product distribution of the Cu catalyst in the direct carbonate cell under different applied current density.
“tr” indicates the FE is lower than 1%.

| j | CO | H₂ | CH₄ | C₂H₄ | C₂H₅OH | HCOO^{—} | C₂H₃O₂^{—} | C₃H₇OH | Total |
|---|---|---|---|---|---|---|---|---|---|
| (mA/cm²) | (%) | (%) | (%) | (%) | (%) | (%) | (%) | (%) | (%) |
| 150 | tr | 75.3 | 1.3 | 6 | 3.6 | 2.2 | tr | 1.1 | 89.5 |
| 200 | tr | 73.8 | 2.5 | 8.3 | 3.3 | 2 | tr | 1.2 | 91.1 |
| 250 | tr | 84.7 | 3.2 | 10.1 | 4.3 | 2.1 | tr | tr | 104.4 |
| 300 | tr | 83.7 | 3.2 | 7.1 | 4.1 | 1.2 | 1.5 | tr | 100.8 |
| 350 | tr | 86.5 | 3.2 | 6.3 | 4.4 | tr | 1.8 | tr | 102.2 |

The following additional references are incorporated herein by reference in their entirety:
(1) Sanz-Perez, E. S.; Murdock, C. R.; Didas, S. A.; Jones, C. W. Direct Capture of CO₂ from Ambient Air. Chem. Rev. 2016, 116 (19), 11840-11876.
(2) Keith, D. W.; Holmes, G.; St. Angelo, D.; Heidel, K. A Process for Capturing CO₂ from the Atmosphere. Joule 2018, 2 (8), 1573-1594.
(3) Verma, S.; Lu, X.; Ma, S.; Masel, R. I.; Kenis, P. J. A. The Effect of Electrolyte Composition on the Electroreduction of CO₂ to CO on Ag Based Gas Diffusion Electrodes. PCCP 2016, 18 (10), 7075-7084.
(4) Dinh, C. T.; Burdyny, T.; Kibria, M. G.; Seifitokaldani, A.; Gabardo, C. M.; Garcia de Arquer, F. P.; Kiani, A.; Edwards, J. P.; De Luna, P.; Bushuyev, 0. S.; Zou, C.; Quintero-Bermudez, R.; Pang, Y.; Sinton, D.; Sargent, E. H. CO₂ Electroreduction to Ethylene via Hydroxide-mediated Copper Catalysis at an Abrupt Interface. Science 2018, 360 (6390), 783.
(5) Li, Y. C.; Yan, Z.; Hitt, J.; Wycisk, R.; Pintauro, P. N.; Mallouk, T. E. Bipolar Membranes Inhibit Product Crossover in CO₂ Electrolysis Cells. Adv. Sustainable Syst. 2018, 2 (4), 1700187.
(6) Verma, S.; Lu, S.; Kenis, P. J. A. Co-electrolysis of CO₂ and Glycerol as a Pathway to Carbon Chemicals with Improved Technoeconomics Due to Low Electricity Consumption. Nature Energy 2019.
(7) Aaron, D.; Tsouris, C. Separation of CO₂ from Flue Gas: A Review. Sep. Sci. Technol. 2005, 40 (1-3), 321-348.
(8) Ho, M. T.; Allinson, G. W.; Wiley, D. E. Reducing the Cost of CO₂ Capture from Flue Gases Using Pressure Swing Adsorption. Ind. Eng. Chem. Res, 2008, 47 (14), 4883-4890.

### Additional Experimentation for C2+ Production

Additional work was performed to assess catalyst materials, substrate properties, and the production of other carbon based products, including ethylene and ethanol.

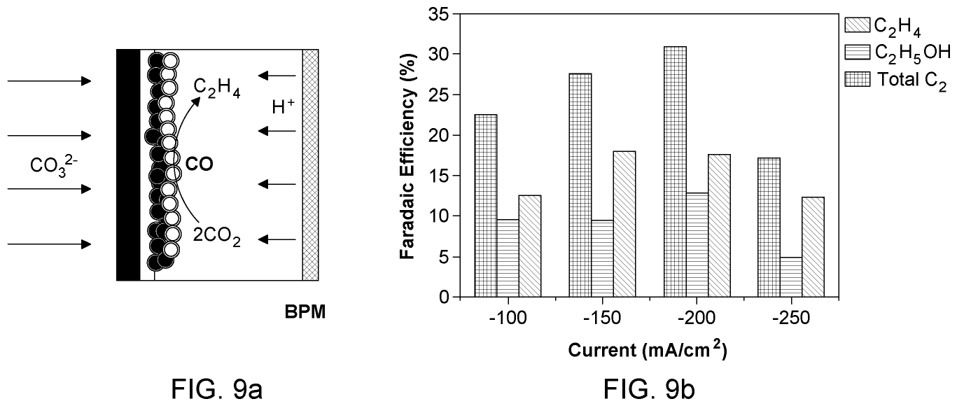

Different catalyst materials and substrate properties were assessed, and results are shown in FIGS. 8a to 8c. In particular, catalyst materials including Cu produced by bare sputtering, Cu/Ag alloy produced by galvanic sputtering, co-sputtering of Ag and Cu (with Ag at 40 W and Cu at 200 W as well as Ag at 100 W and Cu at 200 W), were produced and tested for ethylene faradaic efficiency (see FIG. 8b) and at different current densities (see FIG. 8a). In addition, the substrate onto which the catalyst was deposited was treated with UV to reduce its hydrophobicity and the impact of this substrate was assessed (see FIG. 8c). It was found that Cu/Ag alloy as well as the reduced hydrophobic substrate provided enhanced performance at certain current densities. FIG. 9b shows that using the reduced hydrophobic substrate and Cu/Ag catalyst material facilitated the production of ethylene and ethanol at current densities between 100 mA/cm² and 250 mA/cm² with particularly good performance between 150 mA/cm² and 200 mA/cm². FIG. 9 a schematically shows the conversation of carbonates to form ethylene in the system.

The work also tested different catalysts to change the selectivity of the carbonate reaction from generating syngas to hydrocarbons—a product with larger market demand and better utility. It was investigated whether alloying metal surface would change the reaction selectivity. The work started with Ag/Cu alloy as a demonstration of concept. FIG. 8b shows the ethylene selectivity from the carbonate reaction between bare Cu, galvanically exchanged Ag/Cu, and two samples of co-sputtered Ag/Cu with different ratio of Ag and Cu. Bare Cu was a physically sputtered Cu sample onto a carbon paper substrate. Galvanic Ag/Cu sample was synthesized first with a bare Cu sample, and it was then submerged into an AgNO₃ solution to dope the Cu surface with Ag atoms. Some optimization of the Ag concentration was performed by controlling the deposition time. The two other samples were co-sputtered Ag/Cu with different ratios. Ag and Cu were sputtered together to give nanoparticles of Ag and Cu, but well mixed at the nanoscopic scale.

All samples were tested with 1 M K₂CO₃ solution, and it was found that ethylene production was best with the galvanic Ag/Cu. The results indicate that the distribution of Ag and Cu is a relevant factor, and the atomic level alloying distribution of the catalyst is better for C₂ hydrocarbon production.

The work subsequently studied the hydrophobicity of the cathodic membrane, which was carbon paper for the tests. Cu catalyst was used in all the experiments as similar control. UV treatment of the carbon paper substrate tends to etch away organic residuals on the substrate and the substrate will become more hydrophilic and less hydrophobic. Nafion is an ionic polymer that repels water. The two Nafion samples had small amounts of Nafion added to the substrate surface to increase the hydrophobicity for comparison with the UV treated samples with increased hydrophilicity. FIG. 8c shows the ethylene product selectivity of the different substrates described above. The Nafion based samples show good selectivity at low current density, because at the low current density condition only small amounts of the carbonate solution concentration were needed. At high current density, the UV treated sample outperforms in terms of ethylene production. Based on these control experiments, the work showed that the substrate hydrophobicity is relevant for the liquid carbonate solution to penetrate the electrode and create large surface contact to sustain high current density. In some implementations, the contact angle of the substrate material can be less than 40 degrees, less than 30 degrees, less than 20 degrees, or less than 10 degrees, in term of hydrophilicity. Typical carbon paper would have a contact angle larger than 90 degrees; after UV treatment the carbon paper contact angle is less than 10 degrees. Thus, the substrate could be pretreated, e.g., via UV, to reduce its contact angle by about half or more and by about 50 degrees or more. The substrate could be various porous materials.

Referring to FIG. 9b, based on the optimized performance in the last two figures (FIGS. 8b and 8c), the work showed the product distribution of all C₂ hydrocarbon products (ethylene and ethanol) from the carbonate electrolyzer. Ethylene and ethanol are notable products in terms of potential industrial applications. FIG. 9a shows a schematic of the conversion of carbonate into ethylene.

1. An electrolytic process for converting carbonate into syngas in an electrolysis cell, comprising:
providing a carbonate loaded solution comprising carbonate ions (CO₃²⁻) and having a pH above 11;
feeding the carbonate loaded solution into a cathodic compartment of the electrolysis cell, the cathodic compartment comprising a cathode;
feeding an electrolyte into an anodic compartment of the electrolysis cell, the anodic compartment comprising an anode;
applying a voltage across the anode and the cathode;
generating protons within the electrolytic cell and supplying the protons within the cathodic compartment to react with the carbonate to form CO₂ and water;
electrocatalytically converting the CO₂ into the syngas at the cathode and producing a carbonate depleted solution;
withdrawing the carbonate depleted solution and the syngas from the cathodic compartment and separating the syngas from the carbonate depleted solution.

2. The process of claim 1, wherein the carbonate loaded solution comprises potassium carbonate.

3. The process of claim 1 or 2, wherein the carbonate loaded solution comprises sodium carbonate.

4. The process of any one of claims 1 to 3, wherein the carbonate loaded solution has a CO₃²⁻ concentration of at least 0.5 M and below 2.5 M.

5. The process of any one of claims 1 to 4, wherein the carbonate loaded solution has a CO₃²⁻ concentration of at least 0.7 M and below 2.2 M, optionally between 0.8 and 2.1 M and further optionally between 1 M and 2 M and still further optionally between 1.2 M and 1.8 M.

6. The process of any one of claims 1 to 5, wherein the syngas is produced having an H₂-to-CO ratio of approximately 2:1 to 4:1, optionally approximately 5:2 to 7:2, and further optionally approximately 3:1.

7. The process of claim 6, further comprising supplying at least a portion of the syngas to a Fischer-Tropsch reaction unit to produce hydrocarbons therefrom.

8. The process of any one of claims 1 to 7, wherein the cathode comprises silver (Ag).

9. The process of any one of claims 1 to 8, wherein the anode comprises Nickle (Ni).

10. The process of any one of claims 1 to 9, wherein the electrolytic cell is operated with a current density between 100 and 500 mA/cm², or between 100 and 300 mA/cm², or between 150 and 250 mA/cm².

11. The process of any one of claims 1 to 10, wherein the electrolyte fed into the anodic compartment comprises water and potassium hydroxide (KOH), optionally wherein the electrolyte comprises an aqueous solution with a pH from 7 to 14, preferably KOH, NaOH, and/or CsOH solutions.

12. The process of any one of claims 1 to 11, wherein at least a portion of the carbonate depleted solution removed from the cathodic compartment is used as at least part of an absorption solution that is supplied to a CO₂ absorber that receives a CO₂-containing gas and produces a CO₂-depleted gas and an absorber loaded solution.

13. The process of claim 12, wherein at least a portion of the absorber loaded solution is used as at least a portion of the loaded carbonate solution that is fed into the cathodic compartment.

14. The process of claim 13, wherein all of the absorber loaded solution is fed into the cathodic compartment as the loaded carbonate solution.

15. The process of any one of claims 1 to 14, wherein a recycle portion of the carbonate depleted solution removed from the cathodic compartment is recycled back into the carbonate loaded solution that is fed into the cathodic compartment.

16. The process of any one of claims 1 to 15, wherein the protons are generated using a bipolar membrane located in the electrolysis cell.

17. The process of claim 16, wherein the bipolar membrane is positioned to provide fluid separation between the cathodic compartment from the anodic compartment.

18. The process of claim 17, wherein the bipolar membrane is configured to dissociate water to generate the protons and hydroxide ions, wherein the protons move into the cathodic compartment to react with carbonate and the hydroxide ions move into the anodic compartment.

19. The process of claim 18, wherein the bipolar membrane comprises an anion exchange layer defining a side of the anodic compartment and a cation exchange layer defining a side of the cathodic compartment, and wherein the bipolar membrane is configured such that water is dissociated into the protons and the hydroxide ions when a given potential difference is exceeded; and optionally wherein the anion exchange layer comprises imidazolium based compounds, quaternary ammonium based compounds and/or phosphonium based compounds or any derivatives or polymers thereof; and optionally wherein the cation exchange layer comprises a perfluorosulfonic acid polymer.

20. The process of claim 19, wherein the given potential difference is approximately 0.8 V; and/or optionally wherein the cation exchange layer is provided to have a pKa of approximately −1 to 3, −0.5 to 2, 0 to 1.5, or 1.

21. The process of claim 19 or 20, wherein the bipolar membrane is mechanically reinforced, optionally with a woven polymeric material which is optionally PEEK, polyester, polypropylene, and/or perfluoroalkoxy.

22. The process of any one of claims 16 to 21, wherein the cathodic compartment and the anodic compartment are defined by a housing comprising side walls and separation of the cathodic compartment from the anodic compartment is provided solely by the bipolar membrane positioned within the housing.

23. The process of any one of claims 1 to 22, wherein the protons are generated in a controlled manner in accordance with the CO₃²⁻ concentration of the carbonate loaded solution to convert at least 30%, at least 40%, at least 50% or at least 60% of the carbonate into CO₂ in situ within the cathodic compartment.

24. The process of any one of claims 1 to 23, wherein the protons are generated in an amount of 1e−6 to 5e−6, 1e−6 to 3e−6 or 1.5e−6 to 2.5e−6 mole/sec per 1 cm² of electrode area.

25. The process of any one of claims 1 to 24, wherein the pH of the carbonate loaded solution is above 11.5 upon entering the cathodic compartment, or above 12 upon entering the cathodic compartment.

26. The process of any one of claims 1 to 25, wherein the pH of the carbonate depleted solution upon exiting the cathodic compartment is between 0.2 to 0.4 lower than the carbonate loaded solution.

27. The process of any one of claims 1 to 26, wherein the syngas and the carbonate depleted solution are removed from the cathodic compartment as a single stream and are separated in a downstream separation stage, or wherein the syngas and the carbonate depleted solution are removed from the cathodic compartment as separate streams.

28. The process of any one of claims 1 to 27, wherein the cathode comprises a porous substrate and a catalytic metal provided thereon; and optionally wherein the porous substrate is hydrophilic, optionally composed of carbon paper, further optionally pre-treated with ultraviolet (UV) radiation to increase hydrophilicity; and optionally wherein the substrate has a contact angle that is less than 40 degrees, less than 30 degrees, less than 20 degrees, or less than 10 degrees, in term of hydrophilicity.

29. The process of any one of claims 1 to 28, wherein the carbonate ions in the carbonate loaded solution are fully, mostly, or partially derived from CO₂ extracted from a flue gas or air.

30. An electrolytic process for converting carbonate into a carbon based product in an electrolysis cell, comprising:
feeding a carbonate loaded solution comprising carbonate ions (CO₃²⁻) and having a pH above 10 into a cathodic compartment of the electrolysis cell, the cathodic compartment comprising a cathode;
feeding an electrolyte into an anodic compartment of the electrolysis cell, the anodic compartment comprising an anode;
applying a voltage across the anode and the cathode;
generating protons in situ within the electrolytic cell and supplying the protons within the cathodic compartment to react with the carbonate to form CO₂ and water, the protons being generated by a bipolar membrane positioned between the cathodic compartment and the anodic compartment;
electrocatalytically converting the CO₂ into the carbon based product at the cathode by electroreduction and producing a carbonate depleted solution; and
withdrawing the carbonate depleted solution and the carbon based product from the cathodic compartment and separating the carbon based product from the carbonate depleted solution.

31. The process of claim 30, wherein the carbon based product comprises CO.

32. The process of claim 30, wherein the carbon based product comprises a C2+ carbon compound.

33. The process of claim 32, wherein the C2+ carbon compound comprises ethylene.

34. The process of claim 32 or 33, wherein the C2+ carbon compound comprises ethanol.

35. The process of any one of claims 32 to 34, wherein the C2+ carbon compound comprises formate, acetate, and/or propanol.

36. The process of any one of claims 30 to 35, wherein the carbon based product comprises methane.

37. The process of any one of claims 30 to 36, wherein a plurality of carbon based products are produced, and the process further comprises separating a target carbon compound from the carbon based products.

38. The process of any one of claims 30 to 37, wherein the cathode comprises Cu.

39. The process of any one of claims 30 to 38, wherein the cathode comprises Ag.

40. The process of any one of claims 30 to 39, wherein the cathode comprises a catalytic metal comprising Cu and Ag.

41. The process of claim 40, wherein the catalytic metal comprises a metal alloy comprising a primary catalyst metal and a secondary metal.

42. The process of claim 41, wherein the primary catalyst metal comprises Cu and the secondary metal comprises Ag.

43. The process of claim 41 or 42, wherein the metal alloy is provided on a porous substrate by co-sputtering.

44. The process of claim 43, wherein the primary catalyst metal is sputtered at 150 W to 250 W, optionally at 180 W to 220 W; and/or the secondary metal is sputtered at 20 W to 120 W, optionally at 30 W to 50 W.

45. The process of claim 41 or 42, wherein the metal alloy is provided on a porous substrate by galvanic sputtering.

46. The process of claim 45, wherein the metal alloy is formed by depositing the primary catalyst metal onto the porous substrate, and then contacting the deposited primary catalyst metal with a solution comprising ions of the secondary metal to dope a surface of the deposited primary catalyst metal with the secondary metal; and optionally wherein the molar surface concentration of the secondary metal is between 10% and 30%.

47. The process of claim 46, wherein the primary metal is Cu and is deposited by sputtering, and the secondary metal is Ag and is provided as AgNO₃ in the solution into which the deposited Cu is submerged.

48. The process of any one of claims 30 to 47, wherein the carbonate loaded solution comprises potassium carbonate.

49. The process of any one of claims 30 to 48, wherein the carbonate loaded solution comprises sodium carbonate.

50. The process of any one of claims 30 to 49, wherein the carbonate loaded solution has a CO₃²⁻ concentration of at least 0.5 M, or at least 1 M.

51. The process of any one of claims 30 to 50, wherein the anode comprises Nickle (Ni) and/or one or more of the following: NiFeOₓ, FeCoOₓ, IrOₓ, RuOₓ, and CoOₓ.

52. The process of any one of claims 30 to 51, wherein the electrolytic cell is operated with a current density between 100 and 300 mA/cm², or between 150 and 250 mA/cm², or between 150 and 200 mA/cm².

53. The process of any one of claims 30 to 52, wherein the electrolyte fed into the anodic compartment comprises water and potassium hydroxide (KOH).

54. The process of any one of claims 30 to 53, wherein at least a portion of the carbonate depleted solution removed from the cathodic compartment is used as at least part of an absorption solution that is supplied to a CO₂ absorber that receives a CO₂-containing gas and produces a CO₂-depleted gas and an absorber loaded solution.

55. The process of claim 54, wherein at least a portion of the absorber loaded solution is used as at least a portion of the loaded carbonate solution that is fed into the cathodic compartment.

56. The process of claim 55, wherein all of the absorber loaded solution is fed into the cathodic compartment as the loaded carbonate solution.

57. The process of any one of claims 30 to 56, wherein a recycle portion of the carbonate depleted solution removed from the cathodic compartment is recycled back into the carbonate loaded solution that is fed into the cathodic compartment.

58. The process of any one of claims 30 to 57, wherein the bipolar membrane comprises an anion exchange layer defining a side of the anodic compartment and a cation exchange layer defining a side of the cathodic compartment, and wherein the bipolar membrane is configured such that water is dissociated into the protons and the hydroxide ions when a given potential difference is exceeded.

59. The process of claim 58, wherein the given potential difference is approximately 0.8 V, wherein the bipolar membrane is mechanically reinforced with woven polymer material.

60. The process of any one of claims 30 to 59, wherein the cathodic compartment and the anodic compartment are defined by a housing comprising side walls and separation of the cathodic compartment from the anodic compartment is provided solely by the bipolar membrane positioned within the housing, and optionally wherein the bipolar member is arranged in parallel relation with respect to the cathode and the anode.

61. The process of any one of claims 30 to 60, wherein the protons are generated by the bipolar membrane in a controlled manner in accordance with the CO₃²⁻ concentration of the carbonate loaded solution to convert at least 40% or at least 50% or at least 60% of the carbonate into CO₂ in situ within the cathodic compartment.

62. The process of any one of claims 30 to 61, wherein the protons are generated in an amount of 1e−6 to 5e−6, 1e−6 to 3e−6 or 1.5e−6 to 2.5e−6 mole/sec per 1 cm² of electrode area.

63. The process of any one of claims 30 to 62, wherein the pH of the carbonate loaded solution is above 11, above 11.5, above 12, above 12.5 or above 13, upon entering the cathodic compartment.

64. The process of any one of claims 30 to 63, wherein the pH of the carbonate depleted solution upon exiting the cathodic compartment is between 0.2 and 0.5 lower than the pH of the carbonate loaded solution.

65. The process of any one of claims 30 to 64, wherein the carbon based product and the carbonate depleted solution are removed from the cathodic compartment as a single stream and are separated in a downstream separation stage, or wherein the carbon based product and the carbonate depleted solution are removed from the cathodic compartment as separate streams.

66. The process of claim 65, wherein the carbon based product is generated as a gas phase.

67. The process of claim 65, wherein the gas phase carbon based product is removed from the liquid phase carbonate depleted solution using a gas-liquid separator.

68. The process of any one of claims 30 to 67, wherein the cathode comprises a porous substrate and a catalytic metal provided thereon; and optionally wherein the porous substrate is hydrophilic, optionally composed of carbon paper, further optionally pre-treated with ultraviolet (UV) radiation to increase hydrophilicity; and optionally wherein the substrate has a contact angle that is less than 40 degrees, less than 30 degrees, less than 20 degrees, or less than 10 degrees, in term of hydrophilicity; and optionally wherein the substrate is composed of graphite, Ni, Fe, Cu, Ti, stainless steel and is a foam, sheet or mesh.

69. The process of any one of claims 30 to 68, wherein the carbonate ions in the carbonate loaded solution are fully, mostly, or partially derived from CO₂ extracted from a flue gas or air; and optionally wherein the CO₂ concentration in the air is about 0.3% to 0.5% or about 0.4% and the CO₂ concentration in the flue gas is about 20% to 30% or about 25%.

70. An integrated CO₂ capture and electrocatalytic conversion system, comprising:
an absorber comprising:
a gas inlet for receiving a CO₂ containing gas;
a liquid inlet for receiving an absorption solution;
an absorption chamber coupled to the gas inlet and the liquid inlet for enabling contact between the CO₂ containing gas and the absorption solution to produce a CO₂ depleted gas and a loaded solution;
a gas outlet for releasing the CO₂ depleted gas; and
a liquid outlet for releasing the loaded solution; and
an electrolysis cell comprising:
a cathode unit comprising:
a liquid inlet for supplying a carbonate loaded solution, the liquid inlet being in fluid communication with the liquid outlet of the absorber and under conditions such that the carbonate loaded solution carbonate loaded solution comprises carbonate ions (CO₃²⁻) and has a pH above 10;
a cathodic compartment in fluid communication with the liquid inlet for receiving the carbonate loaded solution;
a cathode positioned in the cathodic compartment for contacting the carbonate loaded solution and electrocatalytically producing a carbon based product and a carbonate depleted solution; and
at least one outlet in fluid communication with the cathodic compartment configured to release the carbonate depleted solution and the carbon based product;
an anode unit comprising:
a liquid inlet for supplying an electrolyte;
an anodic compartment in fluid communication with the liquid inlet for receiving the electrolyte;
an anode positioned in the anodic compartment for contacting the electrolyte and electrocatalytically generating oxygen; and
an outlet in fluid communication with the anodic compartment configured to release the electrolyte;
a bipolar membrane separating the cathodic compartment and the anodic compartment, and configured to:
generate protons that enter the cathodic compartment to react with the carbonate therein to form water and CO₂,
which is electrocatalytically converted into the carbon based product at the cathode; and
generate OH⁻ ions that enter the anodic compartment; and
a power supply coupled to the anode and the cathode to provide a voltage therebetween.

71. The system of claim 70, wherein the absorber is configured to be a direct-contact absorber wherein the CO₂ containing gas and the absorption solution are directly contacted together in the absorption chamber.

72. The system of claim 71, wherein the absorber is a packed column type unit wherein the absorption chamber comprises packing material.

73. The system of any one of claims 70 to 72, wherein the absorber is configured to receive air as the CO₂ containing gas.

74. The system of any one of claims 70 to 73, wherein the carbon based product comprises CO and the cathode further catalytically generates H₂ to form syngas.

75. The system of claim 74, wherein the at least one outlet of the cathode unit releasing the syngas is coupled to an upgrading unit.

76. The system of claim 75, wherein the upgrading unit comprises a Fischer-Tropsh unit configured to receive the syngas from the electrolysis cell and produce hydrocarbons therefrom.

77. The system of any one of claims 70 to 76, wherein the carbon based product comprises a C2+ carbon compound.

78. The system of claim 77, wherein the C2+ carbon compound comprises ethylene, ethanol, formate, acetate, and/or propanol.

79. The system of any one of claims 70 to 78, wherein the carbon based product comprises methane.

80. The system of any one of claims 70 to 79, wherein a plurality of carbon based products are produced, and the process further comprises separating a target carbon compound from the carbon based products.

81. The system of any one of claims 70 to 80, wherein the cathode comprises Cu.

82. The system of any one of claims 70 to 81, wherein the cathode comprises Ag.

83. The system of any one of claims 70 to 82, wherein the cathode comprises a catalytic metal comprising Cu and Ag.

84. The system of claim 83, wherein the catalytic metal comprises a metal alloy comprising a primary catalyst metal and a secondary metal.

85. The system of claim 84, wherein the primary catalyst metal comprises Cu and the secondary metal comprises Ag.

86. The system of claim 84 or 85, wherein the metal alloy is provided on a porous substrate by co-sputtering.

87. The system of claim 86, wherein the primary catalyst metal is sputtered at 150 W to 250 W, optionally at 180 W to 220 W; and/or the secondary metal is sputtered at 20 W to 120 W, optionally at 30 W to 50 W.

88. The system of claim 84 or 85, wherein the metal alloy is provided on a porous substrate by galvanic sputtering.

89. The system of claim 88, wherein the metal alloy is formed by depositing the primary catalyst metal onto the porous substrate, and then contacting the deposited primary catalyst metal with a solution comprising ions of the secondary metal to dope a surface of the deposited primary catalyst metal with the secondary metal, optionally wherein the surface is doped to include 10% to 30% of the secondary metal.

90. The system of claim 89, wherein the primary metal is Cu and is deposited by sputtering, and the secondary metal is Ag and is provided as AgNO₃ in the solution into which the deposited Cu is submerged.

91. The system of any one of claims 70 to 90, wherein the carbonate loaded solution comprises potassium carbonate.

92. The system of any one of claims 70 to 91, wherein the carbonate loaded solution comprises sodium carbonate.

93. The system of any one of claims 70 to 92, wherein the carbonate loaded solution has a CO₃²⁻ concentration of at least 0.5 M, at least 0.7 M, or at least 1 M.

94. The system of any one of claims 70 to 93, wherein the anode comprises Nickle (Ni), NiFeOₓ, FeCoOₓ, IrOₓ, RuOₓ and/or CoOₓ.

95. The system of any one of claims 70 to 94, wherein the power supply of the electrolytic cell is configured to operate with a current density between 80 and 300 mA/cm², or between 200 and 300 mA/cm², or between 230 and 270 mA/cm².

96. The system of any one of claims 70 to 95, wherein the electrolyte fed into the anodic compartment comprises water and potassium hydroxide (KOH).

97. The system of any one of claims 70 to 96, further comprising an absorber recycle line in fluid communication between the outlet of the cathode unit and the liquid inlet of the absorber to provide at least a portion of the carbonate depleted solution as at least part of the absorption solution supplied to the absorber.

98. The system of any one of claims 70 to 97, wherein all of the absorber loaded solution is fed into the cathodic compartment as the loaded carbonate solution.

99. The system of any one of claims 70 to 98, further comprising a return line in fluid communication from the outlet of the cathode unit to the inlet of the cathode unit to provide a portion of the carbonate depleted solution back into the carbonate loaded solution to form a combined feed that is supplied into the cathodic compartment.

100. The system of any one of claims 70 to 99, wherein the bipolar membrane comprises an anion exchange layer defining a side of the anodic compartment and a cation exchange layer defining a side of the cathodic compartment, and wherein the bipolar membrane is configured such that water is dissociated into the protons and the hydroxide ions when a given potential difference is exceeded; and optionally wherein the anion exchange layer comprises imidazolium based compounds, quaternary ammonium based compounds and/or phosphonium based compounds or any derivatives or polymers thereof; and optionally wherein the cation exchange layer comprises a perfluorosulfonic acid polymer.

101. The system of claim 100, wherein the given potential difference is approximately 0.8 V; and/or optionally wherein the cation exchange layer is provided to have a pKa of approximately −1 to 3, −0.5 to 2, 0 to 1.5, or 1; optionally wherein the bipolar membrane is mechanically reinforced, optionally with a woven polymeric material which is optionally PEEK, polyester, polypropylene, or perfluoroalkoxy.

102. The system of any one of claims 70 to 101, wherein the cathodic compartment and the anodic compartment are defined by a housing comprising side walls and separation of the cathodic compartment from the anodic compartment is provided solely by the bipolar membrane positioned within the housing, and optionally wherein the bipolar member is arranged in parallel relation with respect to the cathode and the anode.

103. The system of any one of claims 70 to 102, wherein the power supply is configured such that the protons are generated by the bipolar membrane in a controlled manner in accordance with the CO₃²⁻ concentration of the carbonate loaded solution.

104. The system of any one of claims 70 to 103, wherein the protons are generated in an amount of 1e−6 to 5e−6, 1e−6 to 3e−6 or 1.5e−6 to 2.5e−6 mole/sec per 1 cm² of electrode area.

105. The system of any one of claims 70 to 104, wherein the pH of the carbonate loaded solution is above 11, above 11.5, above 12, above 12.5 or above 13, upon entering the cathodic compartment.

106. The system of any one of claims 70 to 105, wherein the pH of the carbonate depleted solution upon exiting the cathodic compartment is between 0.2 to 0.4 lower than the carbonate loaded solution.

107. The system of any one of claims 70 to 106, wherein the cathode unit has a single outlet for releasing the carbon based product and the carbonate depleted solution as a single stream, and the system further comprises a separator for separating the carbon based product from the carbonate depleted solution.

108. The system of any one of claims 70 to 106, wherein the cathode unit has at least two outlets such that the carbon based product and the carbonate depleted solution are removed from the cathodic compartment as separate streams.

109. The system of claim 107 or 108, wherein the carbon based product is generated as a gas phase.

110. The system of any one of claims 70 to 109, wherein the cathode comprises a porous substrate and a catalytic metal provided thereon; and optionally wherein the porous substrate is hydrophilic, optionally composed of carbon paper, further optionally pre-treated with ultraviolet (UV) radiation to increase hydrophilicity; and/or wherein the porous substrate further optionally has one or more of the following properties: thickness (at 50 kPa) of 180 to 200 microns, bulk density of 0.44 g/cm³, porosity of 70% to 85% or 75% to 80%, gas permeability of 1800 to 2000 ml*mm/(cm²*hr*mmaq), gas permeability (Gurley sec) of 2 to 2.4, electrical resistivity (through plane) of 70 to 80 mΩcm, Flexural Strength of 40 to 50 MPa, Flexural Modulus of 12 to 18 GPa, Tensile Strength of 60 to 70 N/cm, PTFE treated or not, and/or having a Microporous Layer (MPL) or not.

111. The system of any one of claims 70 to 110, wherein the power supply is configured to provide a current density of at least 100 mA/cm², at least 150 mA/cm², at least 200 mA/cm², at least 250 mA/cm², at least 300 mA/cm², or at least 350 mA/cm² and/or of at most 400 mA/cm².

112. The system of any one of claims 70 to 111, further comprising a monitoring assembly configured to measure one or more of the following parameters: pH of the carbonate loaded solution prior to entering the cathodic compartment, temperature of the carbonate loaded solution prior to entering the cathodic compartment, pH of the carbonate depleted solution exiting the cathodic compartment, liquid flow rate of carbonate.

113. The system of claim 112, further comprising a control assembly configured to receive one or more of the measured parameters, and to control one or more of the following variables: pH of the carbonate loaded solution, current density provided by the power supply, flow of the carbonate depleted solution recycled back to the absorber, flow of the carbonate depleted solution returned to the cathodic compartment, the temperature of the carbonate loaded solution prior to entering the cathodic compartment, liquid flow rate of carbonate.

114. An electrolysis cell for converting carbonate into carbon based products, comprising:
a cathode unit comprising:
a liquid inlet for supplying a carbonate loaded solution comprising carbonate ions (CO₃²⁻);
a cathodic compartment in fluid communication with the liquid inlet for receiving the carbonate loaded solution;
a cathode positioned in the cathodic compartment for contacting the carbonate loaded solution and electrocatalytically producing a carbon based product and a carbonate depleted solution, the cathode comprising:
a porous substrate composed of a hydrophilic material; and
a catalytic metal deposited on the porous substrate, the catalytic metal comprising Cu doped with Ag;
at least one outlet in fluid communication with the cathodic compartment configured to release the carbonate depleted solution and the carbon based product;
an anode unit comprising:
a liquid inlet for supplying an electrolyte;
an anodic compartment in fluid communication with the liquid inlet for receiving the electrolyte;
an anode positioned in the anodic compartment for contacting the electrolyte and electrocatalytically generating oxygen; and
an outlet in fluid communication with the anodic compartment configured to release the electrolyte;
a bipolar membrane separating the cathodic compartment and the anodic compartment, and configured to:
generate protons that enter the cathodic compartment to react with the carbonate therein to form water and CO₂, which is electrocatalytically converted into the carbon based product at the cathode; and
generate OH⁻ ions that enter the anodic compartment; and
a power supply coupled to the anode and the cathode to provide a voltage therebetween.

115. An electrolytic process for converting carbonate into a carbon based product in an electrolysis cell, comprising:
providing a carbonate loaded solution comprising carbonate ions (CO₃²⁻);
feeding the carbonate loaded solution into a cathodic compartment of the electrolysis cell, the cathodic compartment comprising a cathode that comprises:
a porous substrate composed of a hydrophilic material; and
a catalytic metal deposited on the porous substrate, the catalytic metal comprising Cu doped with Ag;
feeding an electrolyte into an anodic compartment of the electrolysis cell, the anodic compartment comprising an anode;
applying a voltage across the anode and the cathode;
generating protons within the electrolytic cell and supplying the protons within the cathodic compartment to react with the carbonate to form CO₂ and water;
electrocatalytically converting the CO₂ into the carbon based products at the cathode and producing a carbonate depleted solution;
withdrawing the carbonate depleted solution and the carbon based products from the cathodic compartment and separating the carbon based products from the carbonate depleted solution.

116. The process or system of any one of claims 1 to 115, wherein at least 40%, 50%, 60%, 70% or 80% of the carbonate present in the carbonate loaded solution is converted in the electrolysis cell.

117. The process or system of claim 116, wherein at least some carbonate in the carbonate depleted solution is recycled back into the electrolysis cell, optionally wherein the recycle is controlled to provide a constant carbonate concentration, e.g., within 1 mol %, 2 mol %, 5 mol % or 10 mol %, in the feed to the electrolysis cell.

118. Use of an electrolysis cell for receiving a carbonate loaded solution having a pH of at least 10 and for converting carbonate ions in the carbonate loaded solution into carbon based products selected from carbon monoxide, ethylene, and ethanol.

119. Use of an electrolysis cell for receiving a carbonate loaded solution derived from a CO₂ capture system that captures CO₂ from air or flue gas and converting carbonate ions in the carbonate loaded solution into carbon based products selected from carbon monoxide, ethylene, and ethanol.

120. The process or system or cell or use of any one of claims 1 to 119, further comprising one or more features as defined in any other of the claims and/or as described herein.
